(19) United States
(12) Patent Application Publication
(10) Pub. No.: US 2026/0205501 A1
(43) Pub. Date: Jul. 16, 2026

(54) SYSTEM AND METHOD FOR ADATIVE TRAINING DATA DELIVERY USING DOMAIN-SPECIFIC PERFORMANCE MONITORING REFERENCE TO RELATED APPLICATIONS

(71) Applicant: ICA AI, Inc., Boca Raton, FL (US)

(72) Inventors: Akila Muthukrishnan, Bangalore (IN); Raymond J. Sheppard, Spring Hill, FL (US); Alan W. McCord, Forney, TX (US); Gustavo Manuel Damil Marin, Point Roberts, WA (US)

(21) Appl. No.: 19/547,701

(22) Filed: Feb. 24, 2026

Related U.S. Application Data
(63) Continuation-in-part of application No. 19/546,455, filed on Feb. 23, 2026.
Application No. 19/546,455 is a continuation-in-part of application No. 19/350,012, filed on Oct. 5, 2025, now Pat. No. 12,621,354.
Application No. 19/350,012 is a continuation-in-part of application No. 19/298,256, filed on Aug. 13, 2025, now Pat. No. 12,621,353.
Application No. 19/298,256 is a continuation-in-part of application No. 19/224,748, filed on May 31, 2025, now Pat. No. 12,457,255.
Application No. 19/224,748 is a continuation-in-part of application No. 19/066,192, filed on Feb. 28, 2025, now Pat. No. 12,388,880.
Application No. 19/066,192 is a continuation-in-part of application No. 18/921,443, filed on Oct. 21, 2024, now Pat. No. 12,261,893.
Application No. 18/921,443 is a continuation of application No. 18/751,905, filed on Jun. 24, 2024, now Pat. No. 12,155,700.
(60) Provisional application No. 63/601,645, filed on Nov. 21, 2023.

(51) Int. Cl. H04L 65/1076; H04L 51/02; H04L 65/1096

(52) U.S. Cl. CPC H04L 65/1076; H04L 51/02; H04L 65/1096

(57) ABSTRACT

A system and method for adaptive training data delivery optimization includes a communication management server that receives entity interaction data and generates N(N−1)/2 training data. The server determines whether defined state models with transition probabilities are available, and utilities model-based delivery when available. When defined state models are not available a model-free delivery is used. During delivery, performance effectiveness metrics are received from the AI systems. The metrics include prediction accuracy, learning convergence rate, generalization capability, and computational efficiency. The system identifies a domain and designates primary metrics with domain-specific thresholds. When any primary metric falls below respective domain-specific threshold, an adaptive switching mechanism switches between model-based and model-free delivery or vide-versa with knowledge preservation. When primary metrics pass but a secondary composite metric falls below a universal threshold, the system optimizes the current delivery approach through parameter tuning.

### REFERENCE TO RELATED APPLICATIONS

This application is a continuation in part of U.S. application Ser. No. 19/546,455, filed Feb. 23, 2026, which is a continuation in part of U.S. application Ser. No. 19/350,012, filed Oct. 5, 2025, which is a continuation in part of U.S. application Ser. No. 19/298,256, filed Aug. 13, 2025, which is a continuation in part of U.S. application Ser. No. 19/224,748, filed May 31, 2025, which is a continuation in part of U.S. application Ser. No. 19/066,192, filed Feb. 28, 2025, which is a continuation in part of U.S. application Ser. No. 18/921,443, filed Oct. 21, 2024, which is a continuation of U.S. application Ser. No. 18/751,905, filed Jun. 24, 2024, which claims benefit of U.S. Provisional Application No. 63/601,645, filed Nov. 21, 2023, the disclosures of which are hereby incorporated by reference in their entireties.

### BACKGROUND OF THE INVENTION

### Field of the Art

The disclosure relates to the field of artificial intelligence training systems, and more particularly to the field of optimizing training data delivery through adaptive switching between reinforcement learning methodologies.

### Discussion of the State of the Art

Modern artificial intelligence systems require efficient delivery mechanisms to transfer training data from generation systems to learning systems. The effectiveness of AI training depends not only on training data quality but also on how that training data is formatted and delivered to receiving AI systems. Different AI architectures exhibit varying learning efficiencies depending on how training data is structured and presented during the learning process.

Reinforcement learning approaches represent two fundamentally different paradigms for training data utilization. Model-based reinforcement learning constructs explicit representations of environment dynamics through state models, transition probabilities, and reward functions. These Markov Decision Process (MDP) formulations enable systematic policy optimization through dynamic programming techniques including value iteration and policy iteration. Model-free reinforcement learning, in contrast, learns policies directly from experience without constructing explicit environment models, utilizing neural networks and deep learning architectures to approximate value functions and policies from observed state-action-reward sequences.

Current training data delivery systems employ static, fixed-approach methodologies that fail to account for contextual variations in training scenarios. A system configured for model-based delivery continues using Markov Decision Process formulations regardless of whether the underlying data characteristics support effective state model construction. Similarly, systems configured for model-free delivery persist with neural network-based approaches even when explicit state models would provide superior learning efficiency. This inflexibility results in suboptimal training effectiveness across diverse application contexts.

The challenge of approach selection becomes particularly acute when considering the diverse requirements of different application domains. Healthcare applications demand exceptionally high prediction accuracy due to the critical nature of medical decisions, where incorrect predictions may result in patient harm. Financial services applications similarly require high accuracy and strong generalization capabilities to avoid costly errors in transaction processing and risk assessment. Entertainment and social media applications, while requiring reasonable accuracy, prioritize computational efficiency and rapid convergence to support real-time user interactions and content recommendations.

Existing systems lack mechanisms to evaluate training effectiveness during operation and adapt delivery approaches based on performance feedback. Once a delivery methodology is selected, these systems continue with the chosen approach regardless of actual performance outcomes. Poor convergence rates, low prediction accuracy, weak generalization, or inefficient resource utilization go undetected and unaddressed, resulting in degraded training effectiveness that compounds over extended training periods.

Performance evaluation in current systems, where it exists, typically employs uniform threshold criteria across all application domains. A single accuracy threshold applied uniformly to healthcare, financial, entertainment, and social media applications fails to recognize that different domains have fundamentally different tolerance levels for various performance effectiveness metrics. Healthcare systems require near-perfect accuracy while entertainment systems may tolerate lower accuracy in exchange for faster response times. This one-size-fits-all approach to performance evaluation results in either overly conservative switching that misses optimization opportunities or overly aggressive switching that disrupts effective training processes.

Furthermore, when delivery approach changes do occur in existing systems, they typically discard accumulated learning from the previous approach. Switching from model-free to model-based delivery abandons the implicit state representations learned by neural networks. Switching from model-based to model-free delivery discards the explicit state models and transition probabilities that required significant computational investment to construct. This knowledge loss forces the new approach to begin learning from scratch, negating the training progress achieved prior to switching and introducing substantial delays in reaching optimal performance.

Therefore, there exists a need for adaptive training data delivery systems that dynamically select between model-based and model-free approaches based on performance feedback, current domain, and preserve accumulated knowledge when switching between delivery approaches.

### SUMMARY OF THE INVENTION

Accordingly, the inventor has conceived and reduced to practice, in a preferred embodiment of the invention, a system and method for adaptive training data delivery optimization that dynamically selects and switches between model-based and model-free reinforcement learning approaches based on domain-specific performance thresholds while maintaining training effectiveness through knowledge preservation mechanisms.

According to a preferred embodiment, the system implements a communication management server comprising one or more processors, a memory, and programming instructions that receives entity interaction data and generates of N(N−1)/2 training data. The generated training data comprises multi-dimensional relationship vectors including temporal dimensions, behavioral dimensions, communication frequency dimensions, and channel preference dimensions. The training data further includes relationship labels and domain identifiers that enable domain-specific processing and threshold application.

According to a preferred embodiment, the system determines whether defined state models with transition probabilities are available for the current training context. Responsive to the availability of defined state models, the system utilizes model-based delivery implementing model-based reinforcement learning using Markov Decision Processes (MDP). The MDP approach constructs explicit representations of environment dynamics including state models, transition probabilities, reward functions, and policy generation for optimal action selection. Responsive to non-availability of defined state models, the system utilizes model-free delivery implementing model-free reinforcement learning using neural networks. The neural network approach enables direct policy learning, Retrieval Augmented Generation (RAG) integration, and generative processing for handling novel scenarios.

According to a preferred embodiment, the system receives performance effectiveness metrics from AI systems receiving training data. The performance effectiveness metrics comprise four distinct measurements: prediction accuracy that measures correctness of system predictions, learning convergence rate that measures speed of approaching optimal policies, generalization capability that measures performance on previously unseen scenarios, and computational efficiency that measures resource utilization relative to training progress. These metrics are calculated continuously through monitoring performed at predefined training iteration intervals or after processing defined percentages of training data.

According to a preferred embodiment, the system identifies a domain associated with the training combination data from the domain identifiers and determines, for that domain, which performance effectiveness metrics are designated as primary metrics. Different application domains designate different metrics as primary based on domain-specific requirements and risk tolerances. For healthcare and financial domains where prediction errors carry significant consequences, prediction accuracy and generalization capability are designated as primary metrics with higher thresholds. For entertainment and social media domains where responsiveness is prioritized, computational efficiency and learning convergence rate are designated as primary metrics with comparatively lower thresholds.

According to a preferred embodiment, the system implements a two-tier threshold evaluation. In the first tier, for each primary metric, the system compares the primary metric against its respective domain-specific threshold. The domain-specific threshold is user-configurable and may be specified as a range or a specific number from the range. Responsive to any primary metric being below the respective domain-specific threshold, the system triggers an adaptive switching mechanism that switches the delivery mode between model-free delivery and model-based delivery.

The adaptive switching mechanism implements knowledge preservation to minimize training disruption and avoid redundant computation. When switching from model-free delivery to model-based delivery, the system extracts implicit state representations learned by neural networks to construct explicit state definitions and transition probability estimates for the MDP framework. When switching from model-based delivery to model-free delivery, the system initializes neural network weights using existing state model knowledge to provide a warm start for gradient-based optimization. This bidirectional knowledge transfer ensures that accumulated learning is preserved across delivery approach transitions.

In the second tier, responsive to the primary metrics being above the respective domain-specific thresholds, the system calculates a composite metric for secondary metrics. Secondary metrics are the performance effectiveness metrics remaining after the primary metrics have been designated for the domain. The composite metric represents a weighted combination of secondary metric values. The system compares the composite metric against a universal threshold that applies uniformly across all domains.

Responsive to the composite metric being below the universal threshold, the system optimizes the current delivery approach rather than switching to an alternative approach. Optimization includes parameter tuning including learning rate adjustment to accelerate or stabilize convergence, batch size tuning to improve computational efficiency through parallelization, exploration-exploitation rebalancing to improve convergence, regularization adjustment to improve generalization, and resource allocation optimization to improve efficiency. Responsive to the composite metric being above the universal threshold, the system continues the current delivery approach without modification.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4A is another block diagram illustrating an exemplary hardware architecture of a computing device used in various embodiments of the invention.

FIG. 4B shows a computing system configured to execute the computational methods described in this invention, in accordance with a preferred embodiment.

FIG. 5 is an example system architecture for relationship-based training data generation using the communication management server with adaptive delivery optimization, according to an embodiment of the invention.

FIG. 6 is an illustration of an interaction graph, according to an embodiment of the invention.

FIG. 7 is a flow of an example method for generating relationship fingerprints, according to an embodiment of the invention.

FIG. 8 is a flow diagram of an example method for analyzing the incoming communication metadata to identify communication patterns.

FIG. 9 illustrates different attributes that are considered while generating a multi-attribute trust score, according to an embodiment of the invention.

FIG. 10 depicts a flow diagram of an example method for cross-pollination pattern analysis, according to an embodiment of the invention.

FIG. 11 illustrates the different types of metadata patterns that are used by relationship scoring engine to generate multi-dimensional relationship vectors, according to an embodiment of the invention.

FIG. 12 is a flow diagram of an example method for transformation of the raw metadata patterns into multi-dimensional relationship vectors, according to an embodiment of the invention.

FIG. 13 is a flow diagram of an example method for exponential training data generation, according to an embodiment of the invention.

FIG. 14 is an example flow diagram depicting the temporal evolution of relationship between entities, according to an embodiment of the invention.

FIG. 15 is an example flow diagram depicting the organic growth rate (OGR) calculation and adaptive monitoring method according to an embodiment of the invention.

FIG. 16 is an exemplary graph depicting the Quality Multiplication Factor (QMF) as a function of relationship age, according to an embodiment of the invention, according to an embodiment of the invention.

FIG. 17 is a flow diagram of an example method for adaptive training data delivery approach selection, according to an embodiment of the invention.

FIG. 18 is a block diagram illustrating the components of model-based reinforcement learning using Markov Decision Processes, according to an embodiment of the invention.

FIG. 19 is a block diagram illustrating the components of model-free reinforcement learning using neural networks, according to an embodiment of the invention.

FIG. 20 is a flow diagram of an example method for adaptive switching between model-based and model free approached for training data delivery, according to an embodiment of the invention.

### DETAILED DESCRIPTION

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to fully illustrate one or more aspects of the inventions. Similarly, although process steps, method steps, algorithms or the like may be described in sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of the described processes may be performed in any practical order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the inventions, and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of more than one device or article.

The functionality or features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

One or more different inventions may be described in the present application. Further, for one or more of the inventions described herein, numerous alternative embodiments may be described; it should be appreciated that these are presented for illustrative purposes only and are not limiting the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

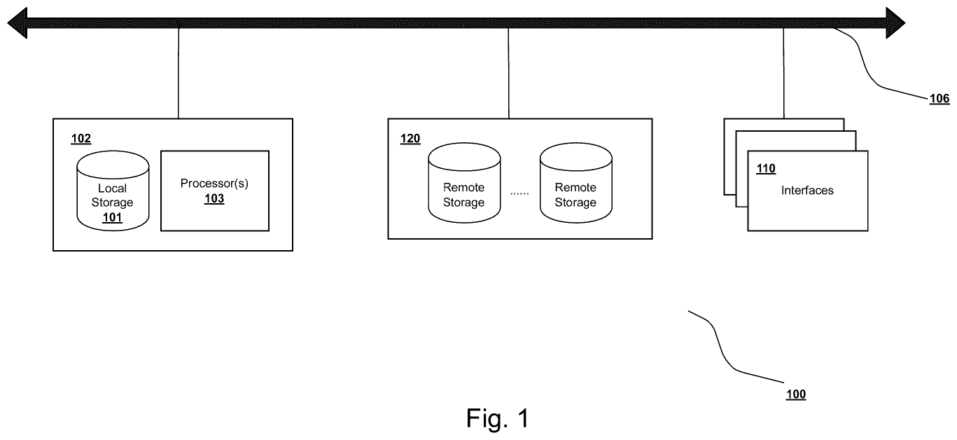

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network, a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control the execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

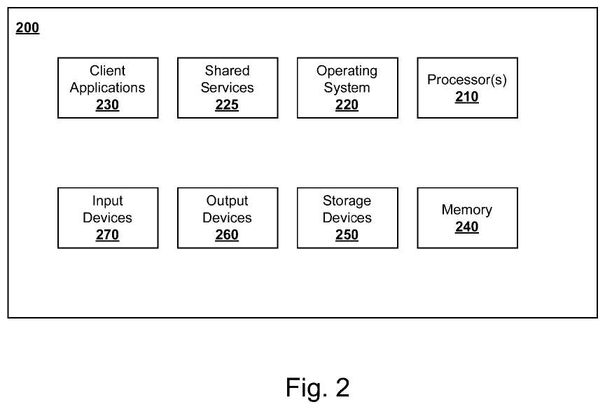

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200 and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example, to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

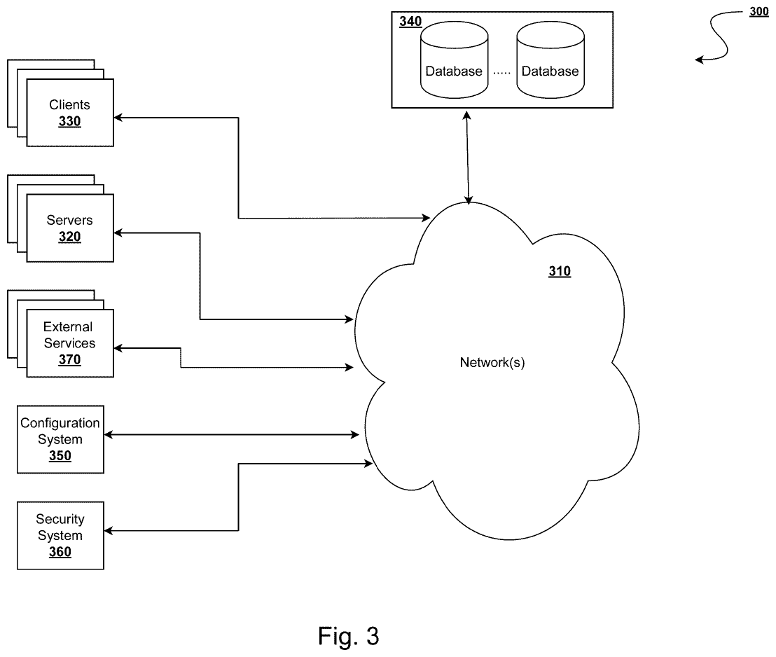

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular incoming communication. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments, one or more databases 340 may comprise a relational database system using a structured query language (SQL), while others may comprise an alternative data storage technology such as those referred to in the art as “NoSQL” (for example, Hadoop Cassandra, Google Big Table, Mongo, and so forth). In some embodiments, variant database architectures such as column-oriented databases, in-memory databases, clustered databases, distributed databases, or even flat file data repositories may be used according to the invention. In addition, Graph-oriented databases, also known as graph databases, are designed to manage and store data structured as graphs, where entities (nodes) are interconnected with relationships (edges), examples include (Amazon Neptune, Microsoft Azure Cosmos DBs, TigerGraph, GraphDB and so forth). These databases are particularly effective for applications involving complex relational queries and traversals, such as social networks, recommendation systems, and network topology analysis.

In addition, vector databases also referred to as vector search databases or similarity search databases, are engineered to index, manage, and retrieve high-dimensional vectors typically generated by machine learning models. These databases are adept at handling operations such as nearest neighbor search in vector space, which is critical for tasks involving image recognition, natural language processing, and recommendation engines, where items are represented as vectors in a multi-dimensional space. Notable examples include Pinecone, Milvus, Weaviate, and Elasticsearch with vector plugins. Vector databases excel in scenarios that require matching patterns or finding similar items based on vector proximity, making them indispensable for modern AI-driven applications such as semantic search, personalization features, and fraud detection systems.

It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each is generally associated with any IT or web systems. It should be understood by one having ordinary skill in the art that any configuration or security subsystems known in the art now or in the future may be used in conjunction with embodiments of the invention without limitation unless a specific security 360 or configuration system 350 or approach is specifically required by the description of any specific embodiment.

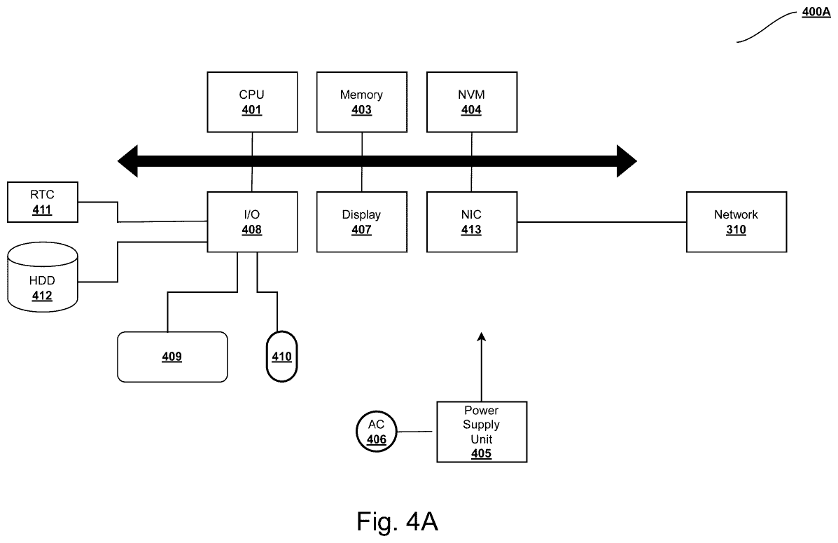

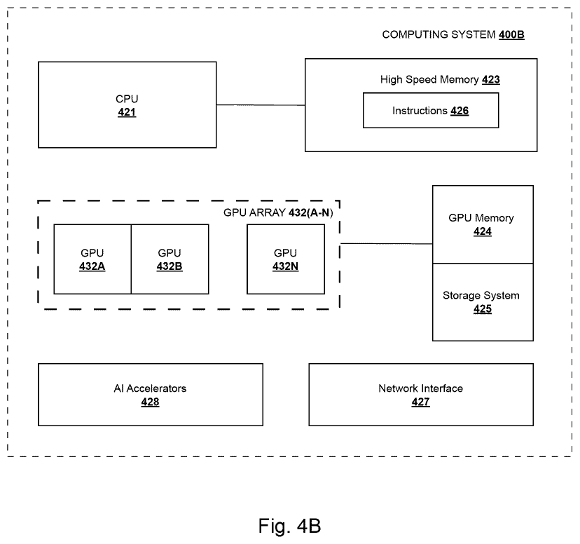

FIG. 4A shows an exemplary overview of a computer system 400A as may be used in any of the various locations throughout the system. It is exemplary of any computer that may execute code to process data. Various modifications and changes may be made to computer system 400A without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which may or may not have connections to the Internet. Also shown as part of system 400A is power supply unit 405 connected, in this example, to ac supply 406. Not shown are batteries that could be present, and many other devices and modifications that are well known but do not apply to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

Referring to FIG. 4B, there is shown a computing system 400B configured to execute the computational methods described in this invention, in accordance with a preferred embodiment. Computing system 400B provides the computational infrastructure necessary to perform the intensive processing operations required by the system. Central Processing Unit (CPU) 421 comprises one or more high-performance processors with multi-core architecture configured to orchestrate communication between system components and manage overall workflow execution. CPU 421 executes control logic, handles API communications with external services, manages iterative processing loops, and performs sequential operations including data parsing, database queries, and coordination tasks. CPU 421 maintains bidirectional communication with high-speed memory for rapid data access and with accelerator hardware for computational offloading. In preferred embodiments, CPU 421 comprises server-grade processors with 8 to 128 cores operating at frequencies between 2.0 GHz and 5.0 GHz, providing the processing power necessary for managing concurrent operations across system components.

High-Speed Memory 423 comprises high-bandwidth random access memory (RAM) configured to store intermediate data structures, active model parameters, and working datasets during processing operations. High-speed memory 423 maintains loaded neural network model weights, active database portions, vectorized representations, intermediate computation results, and temporary data structures. Within High-Speed Memory 423 resides instructions 426 that include the executable software implementing the computational methodology described in this invention. In preferred embodiments, high-speed memory 423 comprises at least 32 GB to 512 GB of DDR4, DDR5, or HBM memory operating at speeds exceeding 3200 MHz to support rapid data access patterns required by the computational algorithms, with larger deployments utilizing up to 2 TB of memory for processing large-scale datasets.

Graphics Processing Unit (GPU) Array 432(A-N) comprises one or more graphics processing units or specialized tensor processing units configured to accelerate parallel computational operations inherent in machine learning and artificial intelligence systems. GPU Array 432(A-N) includes GPU 432A, GPU 432B, through GPU 432N, where N may range from 1 to 16 or more GPUs in distributed configurations. The array dramatically accelerates operations including matrix multiplications, convolution operations, transformer model inference, embedding generation, attention mechanisms, vector similarity computations, and other parallelizable operations common to neural network architectures. The GPUs communicate with CPU 421 via high-speed PCIe 4.0, PCIe 5.0, or CXL interconnects and with each other via NVLink, NVSwitch, Infinity Fabric, or similar GPU-to-GPU communication protocols, enabling efficient multi-GPU parallelization of large batch operations. Each GPU in the array processes different data batches simultaneously, allowing the system to handle high-throughput computational workloads. GPU Array 432(A-N) maintains bidirectional communication with GPU Memory 424 for rapid access to model parameters and computation tensors. In typical configurations, each GPU comprises NVIDIA A100, H100, L40S, AMD MI300, Intel Data Center GPU Max, or equivalent hardware with tensor cores or matrix engines optimized for AI workloads.

GPU Memory 424 comprises high-bandwidth memory (HBM2, HBM2e, or HBM3) or GDDR6/GDDR6X memory integrated with or closely coupled to the graphics processing units, providing extremely fast access to model parameters and computation tensors during neural network operations. GPU memory 424 stores neural network weights, intermediate activation values during forward and backward passes, embedding vectors for rapid similarity computations, gradient tensors during training operations, and cached computation results to minimize redundant operations. In typical configurations, each GPU in the array includes 16 GB to 192 GB of dedicated high-bandwidth memory with bandwidth ranging from 600 GB/s to 3 TB/s per GPU, enabling the rapid data movement required by modern AI architectures. GPU Memory 424 is co-located with Storage System 425, which provides persistent storage for frequently accessed data including model checkpoints, cached activations, and intermediate results. Storage System 425 comprises high-speed Non-Volatile Memory Express (NVMe) solid-state drives (SSDs) with transfer speeds exceeding 7 GB/s, enabling sub-millisecond access to critical data.

AI Accelerators 428 represent optional specialized hardware components that may supplement or replace GPU Array 432(A-N) for specific operations. AI accelerators 428 may comprise Google Tensor Processing Units (TPUs) optimized for matrix multiplication operations, custom Application-Specific Integrated Circuits (ASICs) designed for neural network inference or training, Neural Processing Units (NPUs) integrated with CPU architectures, Field-Programmable Gate Arrays (FPGAs) configured for specialized computational patterns, or other purpose-built hardware accelerators. These accelerators may be particularly advantageous for high-throughput operations, low-latency inference, specialized data transformations, or custom algorithmic implementations. AI Accelerators 428 communicate bidirectionally with CPU 421 for task coordination and data transfer. In some embodiments, AI Accelerators 428 may be deployed in a heterogeneous computing configuration alongside GPU Array 432(A-N), with the system dynamically assigning tasks to the most appropriate hardware based on workload characteristics, availability, and cost-efficiency considerations.

Network Interface 427 provides high-bandwidth connectivity to external networks and services. Network interface 427 enables bidirectional communication with external systems, cloud services, distributed computing resources, databases, and third-party APIs. Network interface 427 implements high-bandwidth connections ranging from 1 Gigabit per second (Gbps) to 400 Gbps to support concurrent operations and data transfers. The interface manages authentication via secure credential handling, implements rate limiting to respect service quotas, provides retry logic with exponential backoff for transient failures, and maintains connection pooling for efficient resource utilization.

### Definitions

Communication patterns refer to patterns extracted from communication metadata. A pattern is derived from analysis of communication metadata including timing, frequency, channel preferences, response latencies, and behavioral characteristics without accessing communication content. Communication patterns represent observable, quantifiable characteristics of interactions between entities. Communication patterns, metadata patterns, and relationship patterns are synonymous terms used interchangeably throughout this specification, all referring to patterns derived exclusively from communication metadata analysis without accessing communication content.

Entity pair refers to two entities between whom a communication relationship exists, identified by their respective entity identifiers. Entity pairs serve as the fundamental unit for relationship analysis and training data generation. Qualified entity pair is an entity pair whose relationship strength score exceeds a predetermined threshold (typically 0.5-0.7), qualifying it for inclusion in training combination data generation.

Performance effectiveness metrics refers to a set of quantitative measurements that evaluate the quality and efficiency of training data delivery. The performance effectiveness metrics comprise four distinct measurements: prediction accuracy, learning convergence rate, generalization capability, and computational efficiency. These metrics are calculated continuously during training operations to assess how effectively the current delivery approach is performing.

As used herein, “model-based delivery” refers to a training data delivery approach that implements model-based reinforcement learning using Markov Decision Processes. Model-based delivery constructs explicit representations of environment dynamics including state models S={s₁, s₂, . . . }, transition probabilities P (s′|s, a), reward functions R(s, a), and policy generation π*(s)=argmax Q(s, a). This approach is selected when defined state models with transition probabilities are available for the training context.

As used herein, “model-free delivery” refers to a training data delivery approach that implements model-free reinforcement learning using neural networks. Model-free delivery learns policies directly from experience without constructing explicit environment models, utilizing neural networks for pattern recognition, direct policy learning, RAG (Retrieval Augmented Generation) integration, and generative processing. This approach is selected when defined state models with transition probabilities are not available for the training context.

As used herein, “adaptive switching” refers to the process of changing from model-based delivery to model-free delivery or vice versa in response to performance effectiveness metrics falling below domain-specific thresholds. Adaptive switching includes knowledge preservation mechanisms that transfer accumulated learning between delivery approaches to minimize training disruption.

### Detailed Conceptual Architecture

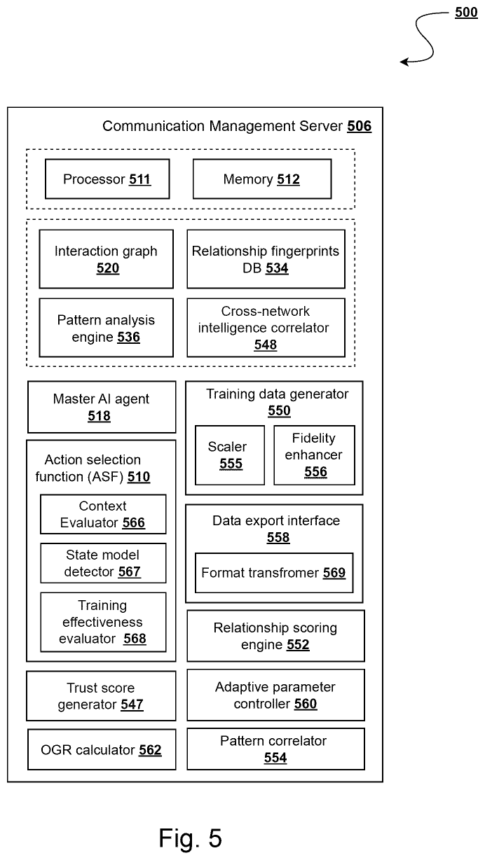

FIG. 5 is an example system architecture 500 for relationship-based training data generation using communication management server 506 with adaptive delivery optimization, according to an embodiment of the invention. System architecture 500 demonstrates how relationship intelligence gathered for communication processing purposes can simultaneously serve as a foundational source for exponential training data generation, creating a dual-purpose system that integrates relationship intelligence gathering with exponential training data generation, while simultaneously implementing adaptive optimization mechanisms that ensure continuous improvement of training data quality and quantity through ongoing operation.

System architecture 500 integrates two complementary operational domains within communication management server 506. First, a training data generation pipeline may continuously collect entity interaction metadata, updates relationship vectors, and regenerates N(N−1)/2 training combinations with quality-enhanced multipliers. Second, an adaptive monitoring and optimization system continuously measures organic growth rate, compares against performance targets, and automatically adjusts system parameters to maintain optimal training data generation.

Communication management server 506 may host multiple integrated components that operate on relationship metadata to produce both communication security services and AI training data. FIG. 5 shows a simplified communication management server 506 of FIG. 5 with emphasis on components used for generation of training data for AI systems. Communication management server 506 includes processor 511 and memory 512, which store and execute the specialized instructions that implement the relationship-based training data generation methodology.

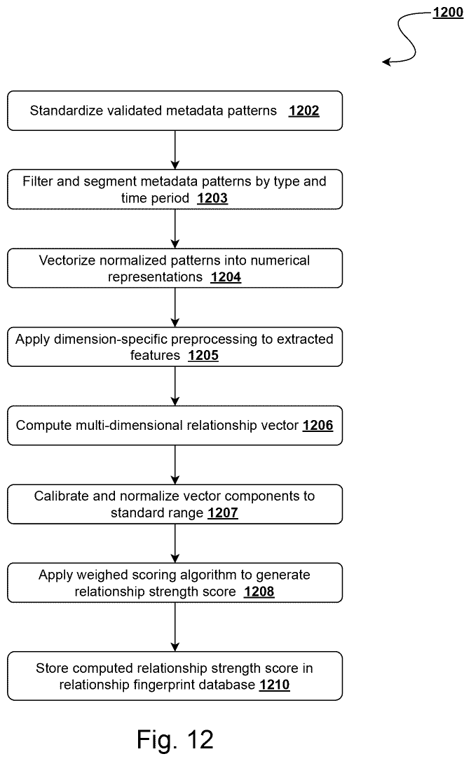

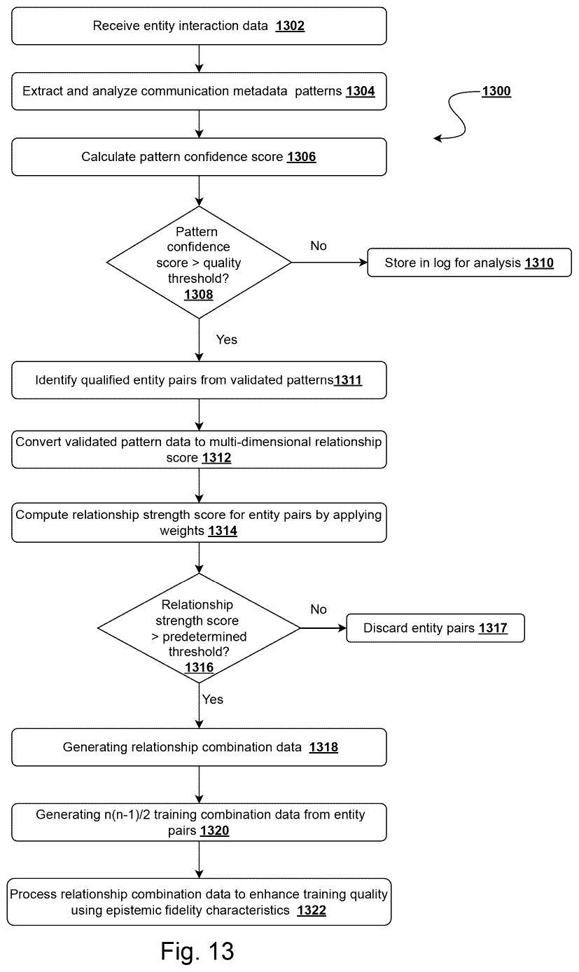

Processor 511 executes the programming instructions that implement methods 1200 (FIG. 12), 1300 (FIG. 13), coordinating the various components to transform entity interaction data into exponentially scaled training data. Further, the processor implements method 1500 that coordinates with OGR calculation, threshold comparison, and stimulation mechanism triggers.

In an embodiment, processor 511 may be a multi-core CPU executing all programming instructions and orchestrating component workflows. Processor 511 maintains real-time awareness of system state, relationship vector evolution, OGR measurements, and parameter adjustments.

Memory 512 may store the programming instructions, intermediate processing results, and the databases that maintain relationship intelligence throughout the training data generation process. In an embodiment, memory 512 may store and maintain a plurality of programming instructions implementing relationship-based training data generation and adaptive optimization, intermediate processing results from each component operation, databases maintaining relationship intelligence throughout the system lifecycle, historical OGR measurements and stimulation adjustment logs, and current parameter settings for fidelity enhancement, temporal window configurations, and dimensional weighting. In an embodiment, memory 512 may be a high-speed RAM maintaining active relationship data structures, multi-dimensional relationship vectors, training combination databases, OGR historical records, and intermediate computation results for rapid access.

Communication management server 506 receives entity interaction data that includes communications between entities operating in healthcare, financial services, education, e-commerce, and social media domains. Entity interaction data encompasses all forms of digital communications including emails, text messages, voice calls, video conferences, instant messages, and social media interactions that occur between entities through the communication management system.

The entity interaction data received by communication management server 506 serves as the input to the training data generation pipeline. This data includes metadata such as timestamps, communication channel identifiers, interaction durations, and participant identifiers, but explicitly excludes communication content, message text, email subjects, voice call transcriptions, or any private information. This metadata-only approach ensures privacy compliance while enabling sophisticated communication pattern extraction. The system captures interaction data without accessing communication content, focusing exclusively on metadata patterns that preserve privacy while enabling relationship analysis.

The plurality of entities represents users, customers, clients, patients, students, or other participants who utilize the communication management server 506 for coordinating interactions across various professional and personal contexts. Multiple communication channels include email systems, messaging platforms, voice communication networks, video conferencing systems, social media platforms, and any other digital communication infrastructure through which entities conduct interactions.

Entity interaction data flows from the communication channels to pattern analysis engine 536, which initiates the training data generation process by extracting and analyzing metadata patterns. In an embodiment, pattern analysis engine 536 may be configured to process incoming communication metadata to identify communication patterns across temporal, frequency, and behavioral dimensions.

In an embodiment, pattern analysis engine 536 may receive entity interaction metadata and extract metadata patterns that are validated and stored in relationship fingerprints database 534. These patterns serve as input for vector creation and quality assessment.

In an embodiment, pattern analysis engine 536 may implement algorithms that extract distinct categories of metadata patterns: temporal patterns (timing distributions and frequencies), behavioral patterns (initiation tendencies and response characteristics), channel patterns (communication method preferences), interaction patterns (communication styles and turn-taking behaviors), trust patterns (consistency and reliability indicators), contextual patterns (professional vs. personal communications), and relationship patterns (engagement levels and relationship strength).

For each pattern category, pattern analysis engine 536 may calculate a pattern confidence score based on data completeness, temporal consistency, and behavioral coherence, and validates patterns against configurable confidence thresholds.

This validation process ensures that only high-quality, statistically significant patterns influence subsequent relationship scoring. Pattern analysis engine 536 operates exclusively through metadata analysis without accessing message content, ensuring complete privacy preservation while extracting sophisticated relationship insights. The validated patterns output by pattern analysis engine 536 serve as inputs to relationship scoring engine 552 for conversion to multi-dimensional relationship vectors.

In an embodiment, relationship scoring engine 552 may convert the validated patterns to multi-dimensional relationship vectors for each entity and compute relationship strength score. The multi-dimensional relationship vectors generated by relationship scoring engine 552 contain the temporal dimensions (capturing communication timing patterns, response latency patterns, and interaction duration patterns), behavioral dimensions (capturing engagement patterns, initiation patterns, and reciprocity patterns), communication frequency dimensions (capturing interaction frequency and cadence patterns), and channel preference dimensions (capturing communication channel usage patterns). Relationship scoring engine 552 may convert validated relationships between entities into multi-dimensional scores through relationship scoring methodology that processes the communication metadata. Detailed related to the process of conversion and score generation are described in FIG. 12.

In an embodiment, relationship fingerprints database 534 serves as the central repository for validated communication patterns identified through metadata analysis. Relationship fingerprints database 534 may store the complete multi-dimensional relationship vectors generated by relationship scoring engine 552, along with relationship strength scores, entity pair identifiers, domain identifiers, relationship labels, and quality metadata.

In an embodiment, relationship fingerprints database 534 may maintain multi-dimensional relationship scores representing entity relationships without storing any communication content. Relationship fingerprints database 534 may implement efficient storage structures optimized for relationship vector retrieval, using specialized indexing to support rapid access based on entity identifiers, relationship characteristics, or strength thresholds.

In an embodiment, relationship fingerprints database 534 provides storage for relationship intelligence that serves both communication security functions and training data generation, enabling continuous learning and pattern evolution through ongoing relationship updates. The relationship vectors and strength scores stored in relationship fingerprints database 534 are retrieved by training data generator 550 to identify qualified entity pairs and generate training combination data.

In an embodiment, trust score generator 547 may calculate relationship trust metrics based on behavioral patterns and historical interaction data, specifically generating the “trust score” dimension of the multi-dimensional relationship vectors. Trust score generator 547 may generates multi-attribute trust scores reflecting relationship strength and quality. Trust score generator 547 may analyze pattern consistency, historical accuracy, and behavioral coherence to generate trust evaluations based exclusively on observable metadata patterns. It implements temporal analysis algorithms that evaluate trust evolution over time, enabling the system to distinguish between developing, stable, and declining trust relationships. The generator incorporates multiple trust attributes including authentication behaviors, relationship authenticity markers, and consistency indicators into a unified trust dimension that significantly impacts overall relationship strength calculations.

Trust score generator 547 enables the system to quantify relationship reliability through sophisticated metadata analysis without requiring access to communication content, addressing a critical dimension of relationship quality while maintaining complete privacy protection. Trust score generator 547 contributes to the relationship characterization that enables high-quality training data generation, providing trust-related features that are particularly important for healthcare, financial services, and other domains where relationship reliability is critical.

In an embodiment, training data generator 550 may process validated communication patterns into exponentially scaled AI training data. Training data generator 550 may identify qualified entity pairs based on relationship strength thresholds, ensuring that only meaningful relationships proceed to training data generation. It creates all possible unique entity pairs from qualified entities while avoiding duplicate pairs and self-references. The combination generation process creates all possible unique entity pairs from qualified entities while avoiding duplicate pairs and self-references. Each entity pair is associated with its corresponding multi-dimensional relationship vector and relationship strength score.

In an embodiment, scaler 555 may process relationship combinations into optimized training data formats, performing the mathematical scaling function that supports the N(N−1)/2 combination formula. Scaler 555 implements mathematical transformations and normalization algorithms that enable efficient processing of the combinatorial explosion inherent in N(N−1)/2 scaling. Scaler 555 implements mathematical transformations that convert raw relationship combinations into feature vectors, target labels, and associated metadata for each relationship combination. Scaler's 555 uses algorithms that enable the system to process massive relationship datasets with logarithmic rather than linear computational complexity, supporting efficient scaling to millions of entities and billions of relationships.

Training data generator 550 outputs training combination data where each combination comprises a multi-dimensional vector with multiple dimensions (temporal, behavioral, frequency, channel), a relationship label indicating relationship classification between the entity pair, and a domain identifier specifying the source domain.

In an embodiment, each training combination data may include a multi-dimensional vector with multiple dimensions, a relationship label and a domain identifier. Further, for each training combination data, training data generator 550 may compute Temporal Evolution Contribution (TEC) and Quality Multiplication Factor (QMF).

TEC measures training data generation rate from vector evolution and QMF computes quality enhancement based on relationship age (1.0× at 1 month, 1.5× at 6 months, 2.0× at 12 months, 2.5× at 24 months)

In an embodiment, organic growth rate calculator 562 may periodically measure the system's training data generation performance. This measurement represents the quantity of new, valuable training data generated purely from temporal evolution of existing relationships, with zero requirement for external data acquisition

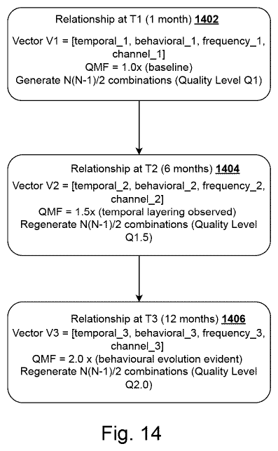

In an embodiment, adaptive parameter controller 560 may execute intelligent parameter adjustments when OGR falls below target threshold. When the measured OGR falls below the target threshold, adaptive parameter controller 560 automatically adjusts system parameters to optimize organic growth rate. Details related to TEC, QMF, OGR and adaptive parameter controller 564 are described in FIGS. 14-16.

In an embodiment, fidelity enhancer 556 may enhance training data quality through epistemic characteristics including temporal layering, behavioral evolution, and contextual adaptivity. The training combination data may be enhanced using epistemic fidelity characteristics to generate training data that is emotionally resonant, temporally layered, symbolically rich, and contextually adaptive.

Fidelity enhancer 556 transforms basic relationship data into rich, nuanced training data with characteristics that make it especially valuable for AI learning, creating training resources that are emotionally resonant, temporally layered, symbolically rich, and contextually adaptive. The fidelity enhancement process significantly increases training data effectiveness, enabling AI systems to learn more sophisticated relationship understanding from fewer examples compared to traditional training approaches.

In an embodiment, fidelity enhancer 556 may implement fidelity processing functions by applying four distinct fidelity characteristics to the training combination data: temporal layering (analyzing temporal evolution patterns to create temporally layered information), emotional resonance (extracting emotional resonance indicators from behavioral patterns and trust scores), symbolic richness (generating symbolic richness through contextual pattern analysis across multiple communication channels), and contextual adaptivity (applying contextual adaptivity by incorporating environmental factors, situational relationship contexts, and domain-specific relationship characteristics.

In an embodiment, fidelity enhancer 556 may analyze temporal evolution patterns within relationship combinations to create temporally layered information that captures how relationships develop and change over time. Fidelity enhancer 556 may extract emotional resonance indicators from behavioral patterns and trust scores, generating training data with sophisticated emotional intelligence characteristics.

In an embodiment, fidelity enhancer 556 may implement contextual adaptivity by incorporating environmental factors, situational relationship contexts, and domain-specific relationship characteristics into the training data enhancement process. Fidelity enhancer 556 creates symbolically rich training data through pattern correlation across multiple communication dimensions, enabling artificial intelligence systems to recognize subtle relationship signals and contextual nuances.

The enhanced training data output by fidelity enhancer 556 is delivered to AI systems through data export interface 558, completing the training data generation pipeline that transforms entity interaction data into exponentially scaled, high-fidelity training data suitable for AI consumption. In an embodiment, cross-network intelligence correlator 548 may identify pattern similarities across different communication channels and validates relationship context.

In an embodiment, fidelity enhancer 556 implements cross-domain learning methodology enabling training data from one application domain to enhance artificial intelligence performance across multiple domains simultaneously through universal relationship pattern recognition. It analyzes relationship patterns across multiple domains to identify common characteristics that transcend domain-specific contexts.

In an embodiment, cross-network intelligence correlator 548 may create connections between domain-specific relationship characteristics and universal relationship features using pattern correlation algorithms that discover non-obvious similarities between different domain patterns. Cross-network intelligence correlator 548 creates a multiplication effect where training data generated in one domain (such as healthcare) can enhance AI training in other compatible domains (such as financial services and education), further amplifying the exponential training data advantage beyond the N(N−1)/2 scaling within individual domains.

In an embodiment, pattern correlator 554 may identify and correlate patterns across entity pairs. Pattern correlator 554 may identify similarities between communication patterns and validate them against known legitimate patterns, ensuring that only high-quality relationships proceed to training data generation. Pattern correlator 554 may implement sophisticated pattern matching algorithms that compare newly identified patterns against established relationship models stored in the system. Pattern correlator 554 may calculate similarity metrics that quantify the degree of alignment between observed patterns and known legitimate communication patterns. Pattern correlator 554 performs multi-dimensional pattern comparison that evaluates similarity across all seven relationship dimensions simultaneously, enabling pattern validation that considers the complete relationship context.

Pattern correlator 554 supports both the quality assurance function within pattern analysis engine 536 (ensuring validated patterns are statistically significant and behaviorally coherent) and the cross-domain compatibility analysis within cross-network intelligence correlator 548 (comparing patterns across domains to identify universal characteristics). This dual role enables pattern correlator 554 to maintain training data quality while enabling cross-domain learning.

In an embodiment, master AI agent 518 may coordinate operations between communication management functions and training data generation processes, performing the orchestration function that ensures all system components work together efficiently. Master AI agent 518 agent may implement supervisory control algorithms that manage data flow, process scheduling, and resource allocation across the entire system architecture. Master AI agent 518 monitors component performance and system health, implementing adaptive resource management that optimizes computational efficiency while maintaining processing quality.

Master AI agent 518 may implement coordinated processing strategies that enable simultaneous communication security and training data generation without resource conflicts or performance degradation.

In an embodiment, action selection function (ASF) 510 coordinates the training data delivery process by determining optimal delivery formats and implementing adaptive switching between reinforcement learning approaches 510 may handle the delivery function of generated training data to AI systems, implementing adaptive reinforcement learning switching logic that determines whether model-based reinforcement learning, model-free reinforcement learning, or dynamic switching between approaches should be used for training data delivery. ASF 510 may implement adaptive reinforcement learning switching logic that determines whether model-based reinforcement learning, model-free reinforcement learning, or dynamic switching between approaches should be used for training data delivery. ASF 510 works in coordination with data export interface 558 to implement the complete adaptive delivery pipeline, ensuring that the N(N−1)/2 training combinations (with their multi-dimensional vectors, relationship labels, and domain identifiers) are packaged and delivered to AI systems in the format most effective for each specific training context.

In an embodiment, ASF 510 that coordinates the adaptive delivery process. ASF 510 includes several specialized components that implement the delivery optimization functionality. Context evaluator 566 may analyze the characteristics of training data and receiving AI systems to inform delivery approach selection.

In an embodiment, state model detector 567 determines whether defined state models with transition probabilities are available for the current training context, enabling the system to select between model-based and model-free delivery approaches. State model detector 567 is a software component within ASF 510 that analyzes training combination data to determine whether defined state models with transition probabilities are available. The state model detector evaluates whether relationship patterns exhibit sufficient structure and consistency to support explicit state model construction, including clear state definitions, observable transition dynamics, and tractable state space complexity. State model detector 567 is implemented as a classification algorithm that outputs a binary determination (available/not available) based on data characteristics analysis.

In an embodiment, training effectiveness evaluator 568 is a software component within ASF 510 that receives performance effectiveness metrics from AI systems and performs two-tier threshold evaluation. The evaluator continuously monitors training performance by analyzing prediction accuracy, learning convergence rate, generalization capability, and computational efficiency. Training effectiveness evaluator 568 implements the domain identification logic, threshold loading, primary metric comparison, secondary composite calculation, and threshold comparison operations described in method 2000. The evaluator is implemented as executable code comprising metric calculation algorithms, threshold comparison logic, and decision tree evaluation

Master AI agent 518 creates a unified operational framework that maximizes infrastructure efficiency through dual-purpose processing, enabling the system to serve both communication security and training data generation functions with minimal computational overhead compared to separate, dedicated systems.

In an embodiment, action selection function (ASF) 510 may determine optimal actions based on communication patterns, supporting both communication routing decisions and training data qualification choices. Based on analysis of relationship context, data availability, and computational requirements, ASF 510 selects the optimal delivery format and monitors performance to ensure the exponentially generated training data is delivered in formats that maximize training effectiveness for each specific scenario.

In an embodiment, data export interface 558 may be configured to deliver generated training data to AI systems through adaptive mechanisms that select optimal delivery methods based on data characteristics and receiving system capabilities. Data export interface 558 delivers generated training data to AI systems through adaptive mechanisms that select optimal delivery methods based on data characteristics and receiving system capabilities.

Data export interface 558 may execute the delivery actions specified by ASF 510, transforming training combination data into model-based formats (state-space representations, transition matrices, reward functions for Markov Decision Processes or model-free formats (experience sequences, state-action-reward-next state tuples for neural network processing) depending on the delivery context evaluation and approach selection.

In an embodiment, data export interface 558 may include format transformer 569, which transforms training combination data between model-based formats suitable for Markov Decision Process consumption and model-free formats suitable for neural network processing. Format transformer 569 enables bidirectional conversion, supporting both initial delivery format selection and format transformation during adaptive switching operations.

In an embodiment, interaction graph 520 may provide relationship context and historical interaction data that informs pattern analysis and relationship scoring throughout the training data generation process. Interaction graph 520 may be a storage of entity relationship graph, with nodes representing entities and edges representing interactions. Interaction graph 520 maintains comprehensive records of entity interactions, relationship evolution, and communication patterns that enable pattern analysis engine 536 to extract validated patterns and relationship scoring engine 552 to generate accurate multi-dimensional relationship vectors. The interaction graph serves as the knowledge base that captures relationship intelligence derived from entity interaction data, enabling both communication management functions and training data generation to leverage accumulated relationship understanding for improved decision-making and data quality.

During continuous generation phase, pattern analysis engine 536 may receive entity interaction metadata and extracts patterns that are stored in relationship fingerprints database 534. These patterns are validated and transformed by relationship scoring engine 552 into multi-dimensional vectors. Training data generator 550 may receive these vectors and apply the N(N−1)/2 formula to generate training combinations. Fidelity enhancer 556 enhances the quality of generated combinations through epistemic characteristics. Data export interface 558 delivers the final training data to external systems for use in AI model training.

During periodic monitoring and optimization phase OGR calculator 562 measures organic growth rate:

$$OGR = ( Sum TEC \times Average QMF ) / Time Period$$

Processor 511 compares measured OGR against configurable target threshold. If OGR is greater than a target threshold system continues normal generation. If OGR is below the target threshold, processor 511 signals adaptive parameter controller 560 for trigger stimulation by adjusting fidelity, temporal window, and/or dimensional weighting. System enters new measurement cycle with adjusted parameters.

System architecture 500 demonstrates the capability to perform dual-purpose processing, where the same relationship intelligence gathered for communication management simultaneously creates exponentially scaled training data for AI systems.

These receiving AI models may include, but are not limited to, large language models, deep neural networks, graph neural networks, reinforcement learning agents, and domain-specific machine learning systems consume the relationship-based training combinations and learn from the multi-dimensional relationship vectors, relationship labels, and domain identifiers to improve their predictive capabilities and decision-making accuracy.

This unified architecture implements privacy-preserving design principles where all processing occurs through metadata analysis without ever requiring access to communication content or private messages.

System architecture 500 addresses fundamental limitations in current AI approaches by implementing relationship-based training data generation that transforms linear entity processing into exponential training data production. The architecture creates a self-improving system where feedback loops between component processes enable continuous refinement and optimization, progressively increasing both training data volume and quality through operational experience. This architecture represents a fundamental advancement in artificial intelligence training approaches, establishing relationship-based artificial intelligence as a distinct processing paradigm that provides exponential scaling advantages compared to traditional data-based artificial intelligence methodologies.

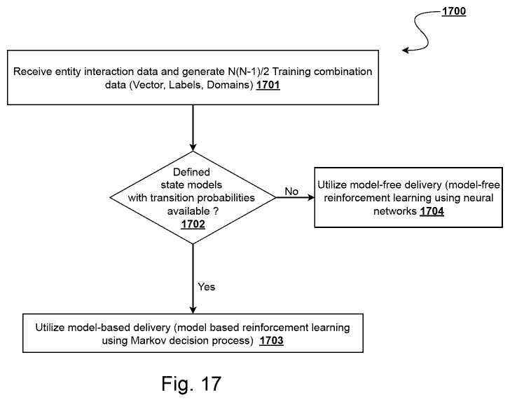

The adaptive delivery optimization illustrated in FIGS. 17-20 is facilitated by several key components within communication management server 506. State model detector 567 determines whether defined state models with transition probabilities are available, enabling the system to select between model-based delivery and model-free delivery. Training effectiveness evaluator 568 continuously receives and analyzes performance effectiveness metrics including prediction accuracy, learning convergence rate, generalization capability, and computational efficiency. When these metrics fall below domain-specific thresholds, adaptive parameter controller 560 implements either approach switching or parameter optimization, with ASF 510 coordinating the transition while preserving accumulated knowledge to maintain training continuity.

### DETAILED DESCRIPTION OF EXEMPLARY EMBODIMENTS

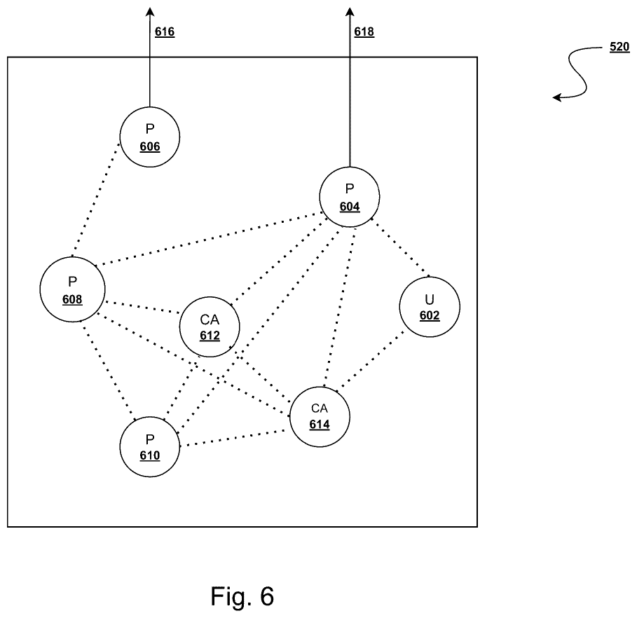

FIG. 6 is an illustration of an interaction graph 520, according to an embodiment of the invention. In this simplified view device nodes are not shown, only party nodes. Each circular node labeled P corresponds to a person, “party”, “entity” or “contact,” and a registered user may be labeled “U,” and the AI communication agents are labeled CA. Registered entity U-602 may use devices (not shown in this figure) for communication. Interaction graph 520 may be stored in memory 512. Interaction graph 520 represents entities (people, companies and software agents) as nodes with relationships and relationships or affinities as edges. The dotted edges in the interaction graph 520 may depict communications interaction relationships between registered entities U-602, with known contacts (P-604, P-606, P-608, P-610), and AI communication agents CA-612 and CA-614. In one embodiment, the edges are weighted by the number of historical interactions between entity pairs and where the absence of an edge indicates no previous direct historical interactions.

In FIG. 6, node U-602 represents a registered entity as a center point or “root” of their interaction network. Surrounding party nodes (P-604, P-606, P-608, and P-610) represent other entities connected to the entity. These may include friends, family, coworkers, and acquaintances, but may also represent the source of incoming communications from people or spam bots entirely unknown to the user. AI communication agents CA-612 and CA-614 may be actively connected with users and contacts dynamically by the master AI agent 518 when making decisions about incoming communications by considering relationships, common attributes, and history.

In an embodiment, AI communication agents at nodes CA-612 and CA-614 may be configured by master AI agent 518 to interact with specific parties. In an embodiment, solid lines 616 and 618 in FIG. 6 may represent actual communication session attempts towards the device of entity 602 triggered from entities P-606 and P-604 respectively. In this example, attempt 618 represents a repeat connection between entities P-604 and U-602 which already have a strong direct communications interaction relationship, whereas attempt 616 represents an attempt to make an initial connection from a device of entity P-606 to a device of entity U-602, which has only a single third level human connection via P-608 and P-604.

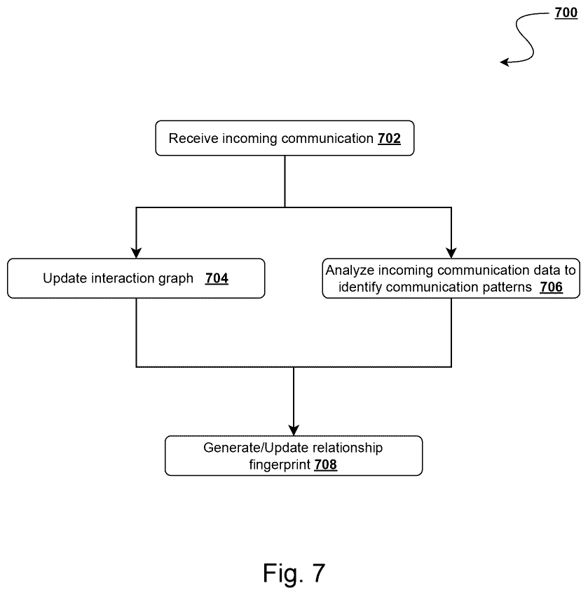

FIG. 7 is a flow of an example method 700 for generating relationship fingerprints, according to an embodiment of the invention. Relationship fingerprints may be generated from interaction graph 520 data and communication patterns and may be constantly updated with the processing of new incoming communications. Relationship fingerprints offer relationship characteristics and may be indicative of established communication behaviors.

At step 702, communication management server 506 may receive an incoming communication via multimedia gateway. The incoming communication may be directed towards an entity among the plurality of entities registered with communication management server 506. The incoming communication may be a voice message, an audio call, a text message, an email, or a video communication.

In an embodiment, relationship fingerprints may provide the unique characteristics of a communication relationship between two entities, and it may include temporal patterns (timing, frequency, duration), channel preferences patterns (voice, text, email), response behaviors (speed, consistency), engagement levels, and relationship context.

The fingerprint continuously evolves as the relationship develops, making it increasingly precise in distinguishing legitimate communications from unwanted ones. Each relationship generates its own unique fingerprint that adapts over time, enabling sophisticated pattern matching while preserving complete privacy since no message content is ever accessed or stored.

At step 704, interaction graph 520 is updated with context associated with the incoming communication. Interaction graph 520 may maintain nodes representing entities and devices, edges representing relationships, and stores communication history and patterns. Interaction graph 520 provides relationship context. For example, new nodes may be added in case of receiving communication from new entities, and edge weights may be updated based on interaction frequency from the identified communication patterns.

At step 706, pattern analysis engine 536 may analyze the metadata associated with the incoming communication data to identify patterns. Pattern analysis engine 536 extracts communication patterns present in communication metadata including timing, frequency of communication, channel preferences, and network-level characteristics without accessing communication content.

At step 708, relationship fingerprint is generated or updated based on the interaction graph 520 data and communication patterns. In case the incoming communication is from a new/unknown user, a new relationship fingerprint may be generated. In case the communication is from a known user and the communication pattern is new, existing relationship fingerprints may be updated with the new pattern.

Each relationship (between two entities) generates its unique fingerprint that adapts over time, enabling sophisticated pattern matching while preserving complete privacy since no message content is ever accessed or stored.

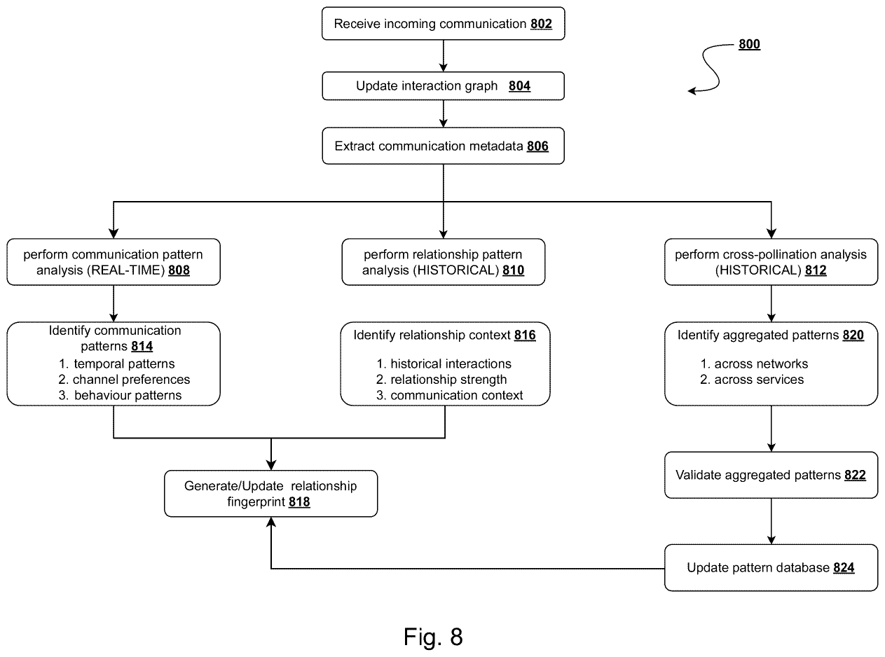

FIG. 8 is a flow diagram of an example method 800 for analyzing the incoming communication metadata to identify patterns.

At step 802, communication management server 506 may receive an incoming communication via multimedia gateway. The incoming communication may be directed towards a first-user device among the plurality of user devices associated with entities. The incoming communication may be a voice message, an audio call, a text message, an email, or a video communication.

At step 804, interaction graph 520 may be updated with context associated with the incoming communication. For example, new nodes may be added in case of receiving communication from new user devices. Interaction graph 520 may maintain nodes representing entities and devices, edges representing relationships, and stores communication history and patterns. Interaction graph 520 provides relationship context. In an embodiment, based on the identified communication patterns interaction graph 520 may be updated. Edge weights may update based on interaction frequency from the identified communication patterns.

At step 806, pattern analysis engine 536 may extract communication metadata associated with the incoming communication data to identify patterns. Pattern analysis engine 536 extracts communication patterns present in communication metadata including timing, frequency of communication, channel preferences, and network-level characteristics without accessing communication content.

Once the metadata is available, pattern analysis engine 536 may perform different types of analysis simultaneously with the available communication metadata.

In an embodiment, at step 808, pattern analysis engine 536 may perform real-time communication pattern analysis to handle immediate pattern detection in incoming communications. At step 814, pattern analysis engine 536 may extract communication patterns related to three main categories: temporal patterns, channel preference patterns, and behavioral patterns. Temporal patterns may be indicative of when and how often people communicate. Temporal patterns may include timing-based patterns like response times, communication frequency, and preferred contact hours. For example, temporal patterns may indicate that a user always responds to work emails within an hour during business hours but takes longer on weekends.

At step 816, pattern analysis engine 536 may identify relationship context based on the historical relationship patterns analyzed at step 810. Relationship context identification comprises three primary components: historical interactions, relationship strength, and communication context.

Historical interactions capture the complete interaction history between the entity pair, including the total number of communications exchanged, the duration of the relationship from first contact to present, interaction milestones such as periods of increased engagement or communication gaps, and evolution of communication patterns over the relationship lifecycle. This historical perspective enables pattern analysis engine 536 to distinguish between established relationships with deep interaction history and newer relationships still developing communication patterns.

Relationship strength quantifies the overall quality and reliability of the relationship based on accumulated pattern evidence. Relationship strength indicators include communication consistency measured through regularity and predictability of interactions, reciprocity balance indicating mutual engagement between entities, response reliability reflecting consistent response behaviors over time, and engagement depth measuring the substantive nature of interactions. Higher relationship strength scores indicate more established, reliable relationships that generate higher-confidence patterns for subsequent processing.

Communication context identifies the situational and environmental factors that characterize the relationship's communication patterns. Communication context indicators include professional versus personal classification based on temporal patterns such as business hours versus evening and weekend communications, formal versus informal communication style markers derived from channel selection and response timing, routine versus urgent communication patterns based on response latency variations, and role-based relationship indicators such as service provider and client, peer-to-peer, or hierarchical communication patterns. The identified communication context enables pattern analysis engine 536 to appropriately interpret patterns within their situational framework, ensuring that context-appropriate behaviors are recognized as legitimate relationship characteristics.

The relationship context identified at step 816, combined with the real-time communication patterns identified at step 814, provides comprehensive input for relationship fingerprint generation and update at step 818.

Channel preference patterns highlight preferred communication methods like calls vs. texts, or switching between channels. For example, a user may prefer using text for quick updates and calls for complex discussions. Similarly, channel-switching behaviors (starting with email and then moving to calls for urgent matters) may also be identified.

Behavioral patterns may indicate interaction styles (brief vs. detailed responses), engagement levels (active participation vs. passive responses), and relationship-specific communication habits (formal with clients, casual with teammates).

In an embodiment, behavioral patterns are extracted exclusively from quantifiable metadata without accessing communication content semantics. The term “interaction style” referenced in behavioral pattern analysis refers to structural characteristics determinable from metadata headers and system logs, not message content.

Pattern analysis engine 536 may analyze message size characteristics available in metadata, including byte count or character count in message metadata. Such metadata is available in email headers, SMS metadata, and voice duration records without requiring access to the actual message content. Classification thresholds are applied to categorize interaction styles based on message size: messages less than 500 bytes indicate a brief communication style; messages between 500 and 2000 bytes indicate a standard communication style; and messages exceeding 2000 bytes indicate a detailed communication style. This approach preserves complete privacy by examining only size metadata without accessing exact message content.

In an embodiment, the system derives engagement intensity indicators from message timestamp metadata compared against historical communication patterns from the same sender. Message timestamps are extracted from communication metadata without requiring content examination. Response patterns are categorized based on temporal delays: responses received within five minutes of the prior communication indicate high engagement and real-time availability; responses received between five minutes and sixty minutes indicate normal engagement levels; and responses received after more than two hours indicate lower urgency or offline status of the recipient. These timing patterns create behavioral fingerprints without any access to message semantic content.

In an embodiment, pattern analysis engine 536 may analyze communication frequency clustering by tallying interaction counts per time period from metadata timestamps. High-frequency clustering, characterized by multiple interactions per day between the same entities, indicates an informal relationship structure with ongoing engagement. Low-frequency clustering, characterized by weekly or monthly interactions, indicates a formal relationship structure with defined communication intervals. Frequency clustering patterns are determinable exclusively from interaction count metadata and temporal distribution, without examining message content.

In an embodiment, the system derives behavioral indicators from the types of communication channels used by each sender, as recorded in metadata channel-type fields. Single-channel exclusive usage, such as exclusive reliance on email for all communications, represents a formal communication style marker. Multi-channel mixing, characterized by the sender utilizing email, SMS, and voice across different communications, represents a casual communication style marker. Channel selection data is a metadata field available in communication headers without requiring content analysis.

In an embodiment, pattern analysis engine 536 may analyze conversation structure through thread and conversation chain metadata without examining message content. Linear threading patterns, characterized by sequential single-threaded conversations following a strict hierarchy, indicate formal or task-oriented communication styles. Parallel conversation patterns, characterized by multiple overlapping topics or simultaneous conversation threads, indicate casual or relationship-oriented communication styles. Message thread metadata reveals structural patterns without any requirement to examine the semantic content of communications.

These metadata-derived behavioral indicators create comprehensive behavioral fingerprints enabling pattern analysis without any access to message semantic content, maintaining complete privacy while identifying meaningful interaction style characteristics. The system never reads the actual message content, never stores message content for pattern analysis purposes, and never transmits message content to pattern database 538. Only quantifiable metadata fields including timestamps, byte counts, channel types, and thread identifiers are processed for behavioral pattern extraction.

In an embodiment, at step 810, pattern analysis engine 536 may perform historical communication pattern analysis to determine relationship strength, context patterns, and interaction history. Relationship strength may be determined based on the depth and frequency of past interactions.

In an example, relationship strength may be measured through factors like communication consistency (regular weekly meetings vs. sporadic interactions), the longevity of the relationship (years of steady contact vs. recent connections), and interaction depth (detailed collaborative projects vs. surface-level exchanges).

The context patterns may be identified based on the different situations and topics in the incoming communication. In an example, context patterns may include recurring discussion topics (regular financial reviews with clients), situational triggers (emergency response patterns), and role-based interactions (manager-employee one-on-ones).

Interaction history may track how relationships evolve between the entities, such as a customer relationship progressing from initial inquiry to long-term account, including changes in communication frequency, formality levels, and trust indicators.

The real-time communication patterns identified at step 814 and historical relationship context patterns identified at step 816 may be used for the generation of a relationship fingerprints between the entities. This relationship fingerprints are constantly updated based on changing patterns, and context between the entities. Further, the relationship fingerprint is also updated with aggregated patterns generated across different services and

In an embodiment, at step 812, pattern analysis engine 536 may perform cross-pollination analysis, to identify common patterns across services and entities/networks. Cross-pollination analysis identifies communication patterns that are found across different services, entities, and networks.

At step 820, pattern analysis engine 536 may identify common patterns that are emerging across different services, users, and networks. In an embodiment, pattern analysis engine 536 may perform cross-pollination pattern analysis by examining communication behaviors across different network types-cellular, VoIP, messaging platforms, etc. This multi-network view enables the detection of sophisticated patterns that might be invisible when looking at a single network. For example, a legitimate business relationship may show consistent patterns across email, voice, and messaging, while fraudulent communications often show inconsistent patterns across different channels.

Any aggregated pattern identified by cross-pollination analysis is normalized so they can be comparable and validated by pattern analysis engine 536. At step 822, pattern analysis engine 536 may validate the identified aggregated patterns by checking the authenticity of pattern against known legitimate patterns, absence of conflicting patterns, cross-service pattern matches, and pattern consistency based on expected relationship behavior from relationship fingerprints.

Through cross-pollinated analysis, pattern analysis engine 536 continuously strengthens its pattern recognition capabilities. When similar patterns are observed across different services (email, voice, messaging), the communication management servers 506 understanding of those patterns becomes more refined and accurate. This learning occurs while maintaining strict privacy boundaries and no personal information or content is shared between services.

At step 822, once the aggregated patterns are validated, then at step 824 a pattern database 538 may be updated. The aggregated patterns stored in pattern database 538 may be used by pattern analysis engine 536 while processing incoming communication. The aggregated patterns may be stored with pattern version, timestamp, source information, and pattern relationship.

Along with using patterns in relationship fingerprints, pattern analysis engine 536 may use aggregated patterns to process incoming communication. Further, in some embodiments, relationship fingerprints may be updated with aggregated patterns.

By analyzing patterns (aggregated patterns) across services and networks, communication management server 506 may be able to identify emerging threat patterns before they become widespread. When unusual patterns are detected in one area, this information is abstracted and shared across the network to enable proactive protection. This creates a self-strengthening security system that becomes more effective as attack patterns evolve, without requiring access to communication content. For example, the same spam pattern may be received by users across voice, SMS, and Email. When a spam pattern is added to communication patterns in relationship fingerprints, any incoming communication with this pattern can be identified, even if the incoming communication has a valid relationship context.

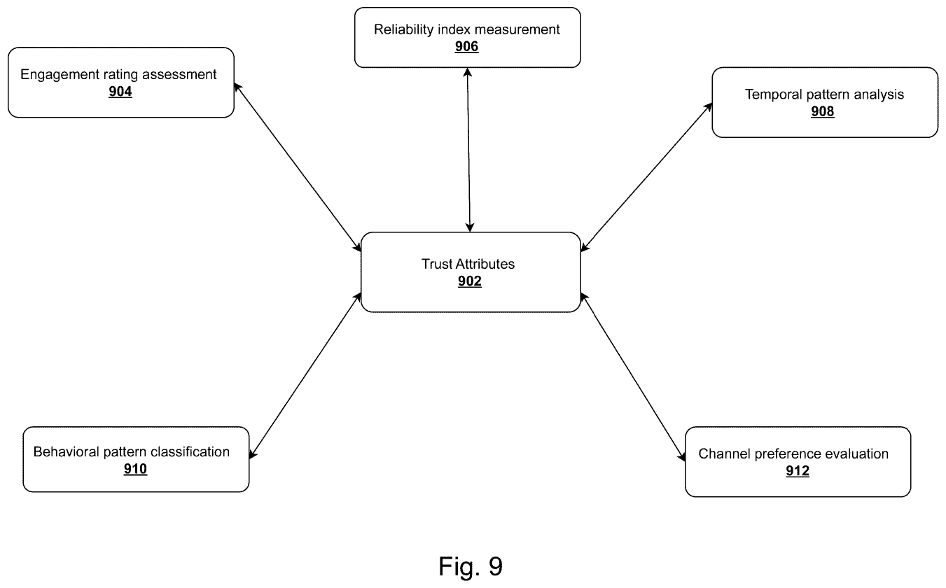

FIG. 9 illustrates different attributes that are considered while generating a multi-attribute trust score, according to an embodiment of the invention. Trust attributes 902 represent the core components that capture different dimensions of communication relationships and provide nuanced trust assessment capabilities that go beyond simple binary classifications.

In an embodiment, engagement rating assessment 902 component may analyze communication frequency, interaction duration, and bidirectional engagement metrics to determine the level and quality of engagement between communicating entities. Engagement rating assessment 902 processes historical interaction data from interaction graph 520 to calculate metrics including average communication frequency, typical interaction duration, response consistency, and mutual engagement indicators. This assessment is indicative of how actively the entities have communicated in the past and provides context for interpreting the current communication within the broader relationship dynamic. The engagement rate is calculated using the formula:

$$Engagement Rate = ( Total Interactions \times Average Duration \times Reciprocity Factor ) / Time Period ,$$

where Reciprocity Factor measures bidirectional engagement quality on a scale of 0.1 to 1.0.

In an embodiment, reliability index measurement 906 component may evaluate the consistency and dependability of communication patterns between entities by analyzing factors such as predictable timing, consistent channel usage, and reliable response behaviors. Reliability index measurement 906 tracks temporal consistency patterns, channel preference stability, and response time reliability to generate scores that indicate the predictability and trustworthiness of the communication relationship. High reliability scores suggest established, consistent communication patterns, while lower scores may indicate new relationships or evolving communication dynamics. The reliability index is calculated as:

$$Reliability Index = ( Temporal Consistency \times Channel Consistency \times Response Consistency ) / 3 ,$$

where each consistency factor is measured on a 0-100 scale.

In an embodiment, temporal pattern analysis 908 component processes timing-related characteristics of communications including preferred contact hours, response timing patterns, communication frequency trends, and temporal consistency indicators. Temporal pattern analysis 908 examines historical timing data to identify when communications typically occur, how quickly entities respond to each other, and whether current communication timing aligns with established patterns. This analysis enables the system to detect unusual timing that might indicate fraudulent communications or legitimate changes in communication circumstances. Temporal patterns are scored using statistical analysis of historical timing data with standard deviation calculations to identify pattern consistency.

In an embodiment, behavioral pattern classification 910 component analyzes interaction styles and engagement behaviors characteristic of the communication relationship, including formal versus informal communication styles, brief versus detailed exchanges, and active versus passive engagement patterns. Behavioral pattern classification 910 processes communication metadata to identify consistent behavioral characteristics that define how entities interact with each other, enabling recognition of authentic communication styles and detection of potential impersonation attempts. Behavioral patterns are classified using machine learning algorithms that analyze metadata characteristics including communication length, response timing, and interaction complexity.

In an embodiment, channel preference evaluation 912 component determines preferred communication methods and channel usage patterns for the relationship, analyzing historical channel selection data to identify primary and secondary communication preferences. Channel preference evaluation 912 tracks how entities typically choose between voice calls, text messages, emails, and other communication channels, providing context for whether the current communication channel aligns with established preferences or represents an unusual deviation that might warrant additional scrutiny. Channel preference scores are calculated as:

$$Channel Preference Score = ( Current Channel Usage Frequency / Total Communications ) \times Channel Appropriateness Factor ,$$

where Channel Appropriateness Factor considers context such as time of day and relationship type.

All trust attributes 902 are generated through privacy-preserving analysis that focuses exclusively on metadata patterns without accessing communication content, ensuring that valuable trust context can be provided while maintaining complete privacy for all entities involved in the communication relationship.

During operation, individual trust attributes 902 generated by these specialized components are integrated with cross-network intelligence correlation results from cross-network intelligence correlator 548 and relationship context validation from interaction graph 520 to generate the overall trust level score. Trust score generator 547 combines the engagement rating, reliability index, temporal patterns, behavioral patterns, and channel preferences with validated cross-pollination patterns and established relationship fingerprints to calculate dynamic trust levels that adapt based on both individual relationship characteristics and collective intelligence from the broader communication ecosystem. This integration ensures that trust level calculations reflect not only the specific relationship dynamics captured by individual attributes but also the broader security insights available through cross-network pattern validation, creating comprehensive trust assessments that leverage both relationship-specific data and ecosystem-wide intelligence while maintaining complete privacy through metadata-only analysis.

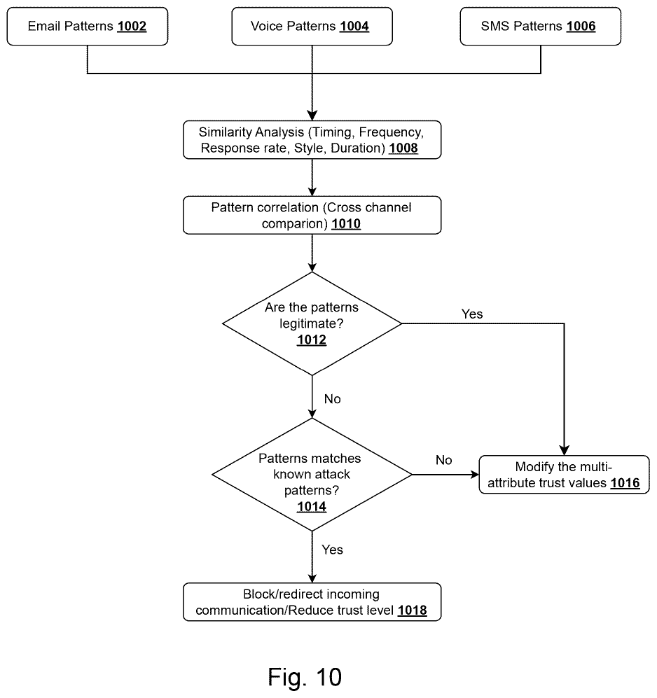

FIG. 10 depicts a flow diagram of an example method 1000 for cross-pollination pattern analysis, according to an embodiment of the invention. Cross-pollination pattern analysis enables identification and validation of communication patterns across different services and networks, according to an embodiment of the invention. The steps of method 1000 may be performed by cross-network intelligence correlator 548 in coordination with pattern analysis engine 536 to create a self-strengthening security and trust framework.

Method 1000 begins with parallel analysis of communication patterns across multiple channels. Email patterns 1002, voice patterns 1004, and SMS patterns 1006 may be simultaneously processed by pattern analysis engine 536 to extract channel-specific characteristics while maintaining privacy through metadata-only analysis. Each channel provides unique pattern signatures including temporal characteristics, frequency patterns, interaction styles, and relationship-specific behaviors that contribute to a comprehensive understanding of communication relationships across the entire ecosystem.

At step 1008, cross-network intelligence correlator 548 may perform similarity analysis examining timing, frequency, response rate, style, and duration patterns across the different communication channels. This similarity analysis employs sophisticated algorithms including correlation analysis, pattern matching, and statistical comparison techniques to identify common characteristics that span multiple communication methods. The similarity analysis enables recognition of legitimate multi-channel relationships while detecting inconsistencies that might indicate fraudulent communications attempting to exploit different channels.

The similarity analysis utilizes cosine similarity calculations, Pearson correlation coefficients, and pattern matching algorithms to quantify relationships between patterns across channels. The system calculates a cross-channel similarity score using:

$$Similarity Score = Σ ( Wi \times Ci )$$

where Wi represents the weight of channel i and Ci represents the correlation coefficient between channels.

At step 1010, cross-network intelligence correlator 548 may conduct pattern correlation through cross-channel comparison to identify relationships and communication behaviors that exhibit consistency across different services and networks. Pattern correlation analysis validates that observed patterns represent genuine relationship characteristics rather than isolated incidents or potential spoofing attempts. This cross-channel validation significantly strengthens the reliability of trust assessments by leveraging the collective intelligence of the entire communication ecosystem. The correlation analysis uses advanced statistical methods including multivariate regression analysis and machine learning algorithms to identify meaningful pattern relationships.

At step 1012, cross-network intelligence correlator 548 may evaluate whether the identified patterns are legitimate by checking consistency with known relationship behaviors, absence of conflicting indicators, and alignment with expected communication evolution. When patterns are determined to be legitimate, the system proceeds to incorporate these validated patterns into relationship fingerprints and continues normal trust score generation. This validation process ensures that natural relationship evolution and changing communication preferences are appropriately recognized and accommodated. The legitimacy assessment uses a weighted scoring algorithm:

$$Legitimacy Score = ( Consistency Weight \times Pattern Consistency ) + ( Context Weight \times Relationship Context ) + ( Deviation Weight \times ( 1 - Pattern Deviation ) )$$

At step 1014, the system performs additional analysis to determine whether current patterns match known attack patterns stored in pattern database 538. Cross-network intelligence correlator 548 compares identified patterns against aggregated threat patterns that have been validated across the network using pattern matching algorithms including hash-based comparison, feature vector analysis, and machine learning classification models. The attack pattern matching utilizes a threat signature database that contains abstracted patterns of known malicious communications, enabling proactive identification of emerging threats before they become widespread. When patterns match known attack signatures, the system proceeds to step 1018 to block or redirect the incoming communication, providing immediate protection against recognized threats.

When patterns do not match known attack patterns but also do not qualify as legitimate, the system proceeds to step 1016 to modify multi-attribute trust values, adjusting trust scores to reflect the uncertainty while providing users with appropriate context for making informed decisions.

Cross-network intelligence correlator 548 provides adjustment factors to trust score generator 547 that modify engagement rate scores when cross-channel patterns show inconsistencies, adjust reliability index values when temporal patterns don't correlate across services, and update channel preference scores when communication methods deviate from validated cross-network behaviors. These modifications ensure that trust attributes reflect not only individual relationship characteristics but also collective intelligence from pattern validation across email, voice, and messaging services, creating dynamic trust levels that adapt based on ecosystem-wide security insights while maintaining the privacy-preserving metadata-only approach. This approach ensures that communications falling into uncertain categories receive appropriate handling without completely blocking potentially legitimate communications or providing false confidence in suspicious interactions. The cross-pollination analysis results from method 1000 are provided to trust score generator 547 for trust attribute calculation.

When patterns are determined to be legitimate at step 1012, this validation strengthens individual trust attribute scores, particularly enhancing reliability index, and behavioral pattern scores based on cross-network consistency. When patterns match known attack signatures at step 1014, the system immediately reduces trust level scores and may override other positive attributes to ensure user safety.

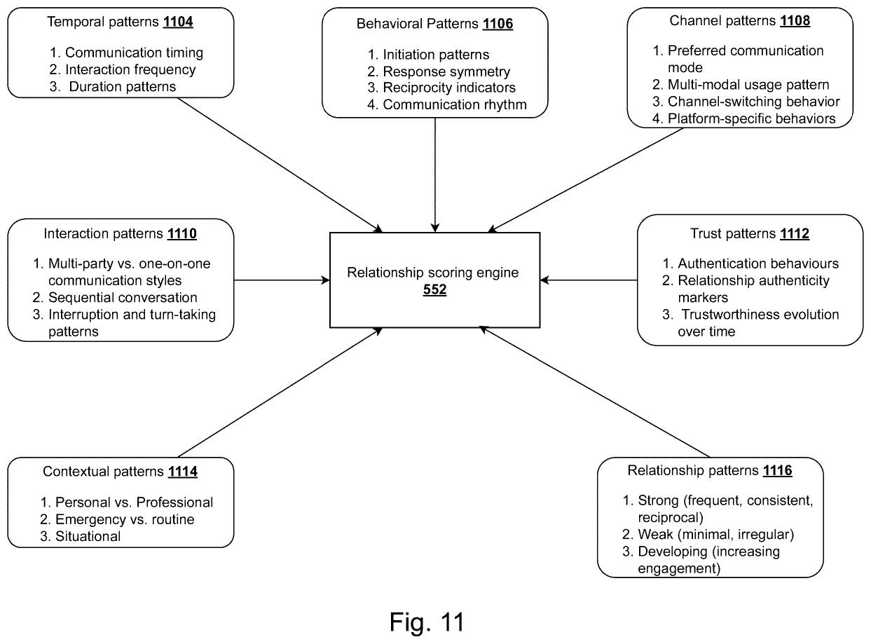

FIG. 11 illustrates the different types of metadata patterns that are used by relationship scoring engine 552 to generate multi-dimensional relationship vectors, according to an embodiment of the invention. FIG. 11 depicts the multiple dimensions of communication metadata patterns that serve as inputs to relationship scoring engine 552.

The pattern categories shown in FIG. 11 represent the diverse metadata signals that relationship scoring engine 552 analyzes to generate the temporal dimensions, behavioral dimensions, communication frequency dimensions, and channel preference dimensions. These patterns are extracted from entity interaction data by pattern analysis engine 536 and processed through the standardization, filtering, vectorization, and preprocessing steps described in FIG. 12 to create the comprehensive multi-dimensional relationship vectors that populate training combination data.

In an embodiment, temporal patterns 1104 may include communication timing preferences, interaction frequency metrics, and duration characteristics that inform temporal and frequency dimensions of the relationship vector. These patterns capture when and how often entities interact without accessing message content.

In an embodiment, behavioral patterns 1106 may include initiation patterns (who starts communications), response symmetry indicators, reciprocity measurements, and communication rhythm analysis. These patterns particularly inform the initiation dimension of the relationship vector while contributing to synchronization measurements.

In an embodiment, channel patterns 1108 may include preferred communication modes, multi-modal usage patterns, channel-switching behaviors, and platform-specific interaction characteristics that directly inform the channel dimension of the relationship vector.

In an embodiment, interaction patterns 1110 may capture communication style preferences including multi-party vs. one-on-one dynamics, sequential conversation management, and turn-taking behaviors. These patterns particularly contribute to the synchronization aspects of relationship scoring.

In an embodiment, trust patterns 1112 may include authentication behaviors, relationship authenticity indicators, and trustworthiness evolution measurements that directly inform the trust dimension of the relationship vector, which typically receives higher weighting in overall relationship strength calculations.

In an embodiment, contextual patterns 1114 may include personal vs. professional context indicators, emergency vs. routine communication signals, and situational adaptation characteristics. These patterns provide critical context for relationship interpretation across different environments.

In an embodiment, communication patterns 1116 measures relationship strength indicators including consistency, reciprocity, engagement level, and relationship lifecycle stage. These patterns help differentiate between strong, developing, and weak relationships.

During operation, relationship scoring engine 552 processes these diverse metadata patterns to generate the multi-dimensional relationship vector. Multi-dimensional relationship may include dimensions that quantify temporal characteristics, frequency metrics, latency measurements, channel preferences, initiation tendencies, synchronization behaviors, and trust indicators. Each dimension may be normalized to a range from 0.0 to 1.0, enabling consistent mathematical processing while preserving complete privacy through metadata-only analysis.

The multi-dimensional representation captures relationship complexities that create training data with epistemic fidelity characteristics including emotional resonance, temporal layering, symbolic richness, and contextual adaptability. FIG. 11 illustrates the metadata pattern diversity that enables relationship scoring engine 552 to generate multi-dimensional relationship vectors, which in turn enable training data generator 550 to create high-quality training combination data through the N(N−1)/2 exponential scaling process. The multiple pattern categories ensure that the resulting training data captures the full complexity of entity relationships while maintaining privacy through metadata-only analysis.

FIG. 12 is a flow diagram of an example method 1200 for transformation of the raw metadata patterns into multi-dimensional relationship vectors, according to an embodiment of the invention. Method 1200 implements the conversion process of validated patterns to multi-dimensional relationship vectors for each entity pair, wherein the multi-dimensional relationship vectors are associated with different dimensions of the metadata patterns. Method 1200 may be executed by processor 511 in coordination with relationship scoring engine 552 by executing instructions stored in memory 512. These instructions, stored in non-transitory computer-readable memory and executed by one or more processors, enable the systematic transformation of raw communication metadata into sophisticated multi-dimensional relationship vectors without accessing communication content.

Relationship scoring engine 552 may coordinate with other system components including pattern analysis engine 536 which supplies validated metadata patterns, and relationship fingerprints database 534 which stores the resulting relationship vectors and strength scores, creating an integrated processing pipeline that serves both communication security functions and exponential training data generation through a unified computational architecture.

Method 1200 depicts the conversion of validated metadata patterns extracted from communication into sophisticated mathematical representations that enable exponential training data scaling. The entire process operates exclusively on metadata without accessing message content, ensuring complete privacy preservation while enabling sophisticated relationship analysis.

At step 1202, relationship scoring engine 552 may standardize validated metadata patterns across different communication contexts and temporal periods. Validated patterns are patterns that have sufficient metadata fields populated for reliable analysis, temporal consistency (communication patterns demonstrate stability over time), and behavioral coherence (identified patterns align with expected relationship characteristics). The validated patterns are metadata patterns that exceed the quality threshold

Heterogeneous metadata gets converted to normalized values that can be consistently processed regardless of source. The normalization applies domain-specific scaling factors to communication timing patterns, frequency distributions, response latencies, and behavioral characteristics, ensuring that patterns from different communication channels (voice, email, messaging) are represented in compatible formats. For example, daily email exchanges are normalized differently than weekly voice calls, yet both are converted to comparable measurement scales through statistical normalization techniques.

At step 1203, relationship scoring engine 552 may filter and segment metadata patterns type and organizes them into relevant time periods. Filtering removes noise and statistical anomalies that could distort the multi-dimensional relationship vectors, while segmentation organizes patterns into coherent groups that reveal different aspects of relationship characteristics. This step removes statistical anomalies and outliers that could distort subsequent processing, applying statistical filtering algorithms to identify and exclude non-representative data points. The system segments temporal patterns into appropriate analysis windows (daily, weekly, monthly), enabling time-scale appropriate processing.

Related metadata is grouped by interaction type and channel, creating coherent pattern sets that reveal relationship characteristics across different communication contexts while maintaining complete privacy through metadata-only analysis. Pattern type segmentation organizes patterns into temporal pattern sets capturing all timing-related metadata, behavioral pattern sets capturing all engagement and interaction style metadata, frequency pattern sets capturing all interaction rate and cadence metadata, and channel pattern sets capturing all communication medium preference metadata. This segmentation by type enables dimension-specific processing in subsequent steps, ensuring that temporal features, behavioral features, frequency features, and channel preference features receive appropriate analytical treatment aligned with their specific characteristics.

At step 1204, pattern vectorization may be performed to transform normalized and filtered patterns into numerical representations suitable for mathematical processing. Vectorization creates the numerical feature representations that will populate the multi-dimensional relationship vector. This step extracts specific quantitative features from the standardized and segmented patterns, converting qualitative relationship observations into precise numerical values.

For temporal dimensions, pattern vectorization may extract numerical features including response timing features (average response latency, response time variance, percentage of rapid responses under 1 hour, percentage of delayed responses over 24 hours), interaction timing features (time-of-day distribution vectors, day-of-week distribution vectors, temporal clustering coefficients), duration features (average interaction duration, duration variance, trend in duration over time), consistency features (temporal regularity score, periodicity measures, timing stability coefficients), and evolution features (temporal trend slopes, acceleration indicators, pattern stability measures).

For behavioral dimensions, pattern vectorization may extract numerical features including engagement features (interaction depth scores, engagement persistence measures, attention investment indicators), initiation features (initiation ratio indicating who starts communications, initiation balance coefficient, initiation pattern consistency), reciprocity features (response reciprocity ratio, interaction balance measures, mutual engagement indicators), synchronization features (coordinated behavior coefficients, alignment scores, behavioral matching indicators), and adaptation features (behavioral responsiveness measures, pattern adaptation rates, style matching coefficients).

For communication frequency dimensions, pattern vectorization may extract numerical features including rate features (interactions per day, per week, per month, normalized frequency scores, density distributions), cadence features (regularity of interaction timing, periodicity indicators, rhythm consistency measures), volume features (total interaction counts, cumulative engagement volumes, communication load indicators), trend features (frequency trajectory slopes, acceleration measures, growth or decline indicators), and burst features (communication burst detection, sustained high-frequency period identification, surge pattern indicators).

For channel preference dimensions, pattern vectorization may extract numerical features including usage features (percentage of interactions per channel type, primary channel indicators, channel distribution vectors), diversity features (channel variety scores, multi-channel usage indicators, breadth of channel adoption), switching features (channel transition frequencies, context-specific channel selection patterns, switching consistency measures), preference features (preferred channel rankings, channel comfort indicators, channel avoidance patterns), and evolution features (changes in channel preferences over time, channel adoption or abandonment indicators). The pattern vectorization may implement mathematical algorithms that preserve essential relationship information while creating compact representations that support efficient computation. This step enables the system to perform vector operations including similarity calculations, clustering, and dimensional analysis on relationship data, preparing the foundation for the multi-dimensional vector generation.

The output of pattern vectorization may be a comprehensive feature set for each entity pair, containing multiple numerical features across the dimension categories. These features form the raw material from which the final multi-dimensional relationship vector will be constructed.

This pattern vectorization may apply dimensional reduction techniques to extract the most significant features from complex pattern data, converting qualitative relationship characteristics into precise numerical values. The pattern vectorization may implement mathematical algorithms that preserve essential relationship information while creating compact representations that support efficient computation. This step enables the system to perform vector operations including similarity calculations, clustering, and dimensional analysis on relationship data, preparing the foundation for the multi-dimensional vector generation.

At step 1205, relationship scoring engine 552 may refine the vectorized data by applying dimension specific preprocessing for the extracted feature. Dimension-specific preprocessing recognizes that different types of features require different analytical treatments to maximize their predictive value and reliability. This preprocessing may enhance the quality of features before they are assembled into the final multi-dimensional relationship vector. Different preprocessing techniques may be applied to temporal features, channel features, behavioral features, and trust-related features, enhancing the signal-to-noise ratio for each dimension.

For temporal features, preprocessing may include outlier suppression for abnormal timing events that don't reflect typical patterns, smoothing algorithms to reduce random timing variations while preserving meaningful patterns, normalization to account for time zone differences and business hour variations, and aggregation across multiple time scales to capture both short-term and long-term temporal patterns.

For behavioral features, preprocessing may include consistency validation to ensure behavioral patterns are stable across observation periods, context adjustment to account for situational factors affecting behaviors, reciprocity balancing to properly represent asymmetric but healthy relationships, and engagement calibration to account for different baseline engagement levels across relationship types.

For frequency features, preprocessing may include rate normalization to account for natural frequency variations across channels and contexts, trend extraction to separate underlying frequency patterns from random fluctuations, seasonal adjustment to account for predictable frequency variations (holidays, business cycles), and burst filtering to distinguish meaningful communication surges from anomalous spikes.

For channel features, preprocessing may include availability adjustment to account for which channels are accessible to entities, preference extraction to distinguish chosen channels from default or forced channels, diversity normalization to account for different channel ecosystems across domains, and consistency validation to ensure channel patterns are stable and representative.

The preprocessing validates feature stability across multiple observation periods, ensuring that only consistent, reliable patterns influence the final vector. The system calculates correlation coefficients between different pattern features, identifying interdependencies that inform subsequent weighting decisions and dimensional analysis. The correlation analysis identifies relationships between features that help interpret their combined meaning. For example, high initiation ratio combined with high reciprocity indicates a strong bidirectional relationship despite initiation imbalance, while high frequency combined with low engagement depth might indicate superficial rather than deep relationship engagement.

At step 1206, relationship scoring engine 552 may compute a multi-dimensional relationship vector for each entity pair. The multi-dimensional relationship vector is the one of the outputs of method 1200, representing the complete numerical characterization of a relationship between an entity pair based on metadata patterns. This vector contains all the features extracted, normalized, and refined through the previous steps, organized by dimension categories.

In an embodiment, the multi-dimensional relationship vector comprises multiple dimensions including, but not limited to, temporal dimensions, behavioral dimensions, communication frequency dimensions, and channel preference dimensions capturing communication channel usage patterns.

Each dimension category contains multiple features as extracted during vectorization (step 1204) and refined during preprocessing (step 1205). The resulting multi-dimensional relationship vector is a comprehensive numerical representation of the entity pair relationship, containing dozens of features organized across the four primary dimension categories.

In an embodiment, the multi-dimensional relationship vector may be a seven-dimensional relationship vector capturing the dimensionality of entity relationships. This seven-dimensional representation can be understood as an alternative or complementary structure where the multiple features within each dimension category are aggregated into summary dimension scores. Each dimension represents a specific facet of relationship characteristics, with values normalized between 0.0 and 1.0 for consistent processing.

The system measures twenty specific characteristics of the relationship (response latencies, interaction frequencies, channel preferences, initiation patterns, etc.). These twenty measurements are organized into four categories: temporal features (timing-related), behavioral features (engagement-related), frequency features (interaction rate-related), and channel features (communication method-related). Each of the twenty measurements is normalized to a scale of 0.0 to 1.0 so they can be compared fairly despite their different units (seconds, counts per week, percentages, etc.).

The four groups are then combined using weighted averages to create the four primary dimension scores (temporal, behavioral, frequency, channel). For example, temporal score combines all seven timing-related measurements with each given an appropriate weight (response latency gets higher weight than trend slope, for instance). Three additional scores (trust, engagement, stability) are derived by recombining the twenty features in different proportions to highlight specific aspects of the relationship.

For example, a temporal dimension score may quantify timing patterns including communication frequency, time-of-day distributions, and day-of-week patterns by aggregating multiple temporal features into a single 0.0-1.0 score. A temporal score near 1.0 means interactions happen at consistent times with predictable response rates. A score near 0.0 means timing is erratic and unpredictable. The temporal score is indicative of how predictable and reliable the timing of interactions is.

A frequency dimension score may measure interaction rate over time, capturing relationship engagement through quantifiable metrics by aggregating multiple frequency features. A latency dimension score may evaluate response times between communications, revealing relationship dynamics through timing patterns by aggregating multiple response latency features. A frequency score measures how often people interact and whether interaction rates are stable or changing. A high score means consistent regular interactions; a low score means sporadic or rapidly changing interaction patterns.

A behavioral score measures how balanced and reciprocal the relationship is. Behavioral score measures how balanced and reciprocal the relationship is. High scores indicate both entities engage equally; low scores indicate one entity dominates interactions. High scores indicate both entities engage equally; low scores indicate one entity dominates interactions.

An engagement score measures how deeply involved and active the relationship is. High scores indicate frequent, detailed interactions; low scores indicate minimal, superficial contact. A stability score measures whether the relationship is mature and established. High scores indicate long-standing, predictable relationships; low scores indicate new or rapidly evolving relationships.

A channel dimension score may assess communication preferences across different methods by aggregating multiple channel usage features. An initiation dimension score measures communication initiation balance between entities by aggregating initiation pattern features. A synchronization dimension score may evaluate coordination patterns including simultaneous activities by aggregating behavioral synchronization features. A channel score measures whether people have preferred communication methods. High scores indicate strong channel preferences and predictable channel selection; low scores mean random channel switching.

A trust dimension score may quantify relationship reliability through pattern consistency by aggregating trust-related features including temporal consistency, behavioral coherence, and interaction reliability indicators. A trust score measures the reliability and consistency of the relationship. This combines several factors like whether people do what they say they'll do and whether patterns remain stable over time.

The relationship between the multi-dimensional relationship vector (with multiple features across dimension categories) and the multi-dimensional score vector is that the individual scores are derived aggregations of the underlying multi-dimensional feature set. The full multi-dimensional relationship vector preserves detailed feature information for use in training data generation, while the multi-dimensional score vector provides a more compact representation useful for relationship strength calculation.

The multi-dimensional score vector (with one aggregated score per dimension) is used when calculating relationship strength scores, as it provides a computationally efficient summary. The system may generate both representations simultaneously, storing the full multi-dimensional relationship vector for training data generation while also computing the seven-dimensional score vector for filtering and strength assessment.

In an embodiment, a seven-dimensional vector may be generated with seven dimensions including temporal, behavioral, frequency, channel, trust, engagement, stability.

At step 1207, relationship scoring engine 552 may perform calibration and normalization of the vector components. This step ensures that all dimensions use consistent value ranges and scaling, applying statistical techniques to standardize each dimension to the 0.0-1.0 range regardless of raw value distributions.

The calibration process adjusts each feature and dimension to account for domain-specific baselines (different domains such as healthcare, finance, education, e-commerce, and social media have different natural patterns, and calibration adjusts features to domain-appropriate scales), relationship type variations (professional relationships, personal relationships, and transactional relationships exhibit different characteristic patterns, and calibration accounts for these differences), temporal context effects (communication patterns vary based on relationship age and maturity, and calibration adjusts for these lifecycle effects), and population-level distributions (features are calibrated against population statistics to ensure scores reflect relative position within expected ranges).

Vector components are calibrated against domain-specific benchmarks derived from established communication patterns, ensuring consistent interpretation across different relationship types and contexts. For example, a response latency of 2 hours might indicate high responsiveness in email-based professional relationships, moderate responsiveness in text messaging contexts, or low responsiveness in real-time chat environments. Calibration ensures this same absolute latency value receives appropriately scaled scores in each context.

Dimensional significance analysis informs subsequent weighting by evaluating the relative importance of each dimension for different relationship categories. This analysis examines which dimensions have highest predictive power for relationship quality in each domain, which dimensions show greatest variance and therefore carry most information, which dimensions are most stable and reliable across observation periods, and how dimensions correlate with each other and with outcome measures. The significance analysis produces domain-specific and relationship-type-specific insights that guide the weighting algorithms applied in the next step. This calibration creates standardized vectors that support mathematical comparison and combination operations in later processing stages including relationship strength score calculation, entity pair qualification, and training combination data generation

At step 1208, relationship scoring engine 552 may apply weighted scoring algorithms to generate a multi-dimensional relationship score from the multi-dimensional relationship vector, Mathematical operations may be used to apply different weights to each dimension based on relationship type and application domain.

Typically, temporal and trust dimensions receive higher weights in overall relationship strength calculation, as these dimensions often provide stronger indicators of relationship quality. The weighted scoring implements mathematical formulas that compute a relationship strength score normalized between 0.0 and 1.0, providing a standardized metric for relationship evaluation and qualification. Scores approaching 1.0 indicate strong, reliable, high-quality relationships with consistent patterns across all dimensions. Scores near 0.0 indicate weak, unreliable, or inconsistent relationships. Mid-range scores indicate relationships with moderate strength or mixed characteristics across dimensions.

Further, as different application domains have different characteristics and requirement, the applied weights may vary based on domain. In healthcare, trust and reliability are paramount. Medical decisions depend on consistency and reliability. The system weights trust-related dimensions heavily in healthcare domain calculations.

In finance, responsiveness and predictability matter. Financial markets move quickly, and advisors need to respond rapidly to client inquiries. The system weights temporal (response time) dimensions heavily.

In education, engagement and participation matter most. Learning effectiveness depends on active participation. The system weights engagement dimensions heavily.

In e-commerce, frequency and channel consistency matter. Customers value regular promotions and multiple purchase options. The system weights frequency dimensions heavily.

In social media, frequency and engagement dominance. These platforms thrive on high interaction frequencies and visible engagement. The system weights frequency and engagement heavily. Domain-specific weighting ensures the system appropriately reflects what matters in each context.

The relationship strength score provides a single numerical measure that quantifies the overall quality and reliability of the entity relationship based on the comprehensive analysis of all metadata patterns. The bidirectional relationship between entities is evaluated by combining vector scores from both directions, analyzing reciprocity, balance, and mutual engagement patterns. Bidirectional evaluation recognizes that relationships may be asymmetric, where entity A has different interaction patterns toward entity B than B has toward A. The system examines reciprocity (do both entities engage similarly?), initiation balance (is communication initiated relatively equally?), response symmetry (do both entities respond with similar latency and engagement?), and mutual consistency (are patterns stable from both perspectives?). The bidirectional analysis may adjust relationship strength scores to account for healthy asymmetric relationships (such as student-teacher or patient-provider relationships where asymmetry is expected) versus unhealthy asymmetric relationships (where one entity is highly engaged but the other is not, indicating weak relationship quality).

The strength calculation incorporates temporal evolution analysis to identify developing versus established relationships by examining how patterns change over time. Developing relationships show increasing engagement, strengthening patterns, and evolving characteristics, while established relationships demonstrate stable, mature patterns. The relationship strength score may be adjusted based on relationship maturity, with established relationships receiving higher confidence than newly developing relationships with limited history.

The system applies mathematical functions that generate strength scores for each entity pair. Relationship scoring engine 552 determines which entity pairs qualify for subsequent combination generation in the training data production process. Entity pairs with relationship strength scores exceeding the predetermined threshold (typically 0.5-0.7, but configurable) become qualified entity pairs that proceed to training combination data generation as described in FIG. 13. Entity pairs with scores below the threshold are filtered out, ensuring that only high-quality relationships generate training data.

Determining entity pairs for combination generation is described in steps 1311-1318, where qualified entity pairs are used to generate N(N−1)/2 training combination data.

At step 1210, the computed relationship strength scores may be stored in relationship fingerprints database 534 for subsequent processing and retrieval. Fingerprints database 534 may maintain the complete set of multi-dimensional relationship vectors along with their computed strength scores, creating a persistent repository of relationship representations that supports both communication security functions and training data generation.

The database stores for each entity pair: the complete multi-dimensional relationship vector with all features across all dimension categories (temporal, behavioral, frequency, channel), a multi-dimensional summary score vector (if computed), the relationship strength score, entity identifiers for the pair, temporal context including when the vectors were computed and the time period they represent, domain identifier indicating the source domain (healthcare, financial services, education, e-commerce, or social media, relationship label indicating the relationship classification (if available), quality metadata including pattern confidence scores and feature stability indicators.

The storage implementation includes efficient indexing structures that enable rapid retrieval based on entity identifiers, relationship characteristics, or strength thresholds. Indexing enables quick lookup of all relationships for a specific entity, filtering of entity pairs by relationship strength threshold for training data generation, retrieval of relationships matching specific characteristic patterns, temporal queries to access relationship states at different time points, and domain-specific queries to access relationships from particular application. Application domain (or simply domain) refers to a specific industry or context in which the communication management system operates.

The stored multi-dimensional relationship vectors serve as the foundation for training combination data generation. When method 1200 completes for all entity pairs in a population, and relationship fingerprints database 534 contains the complete set of relationship vectors N(N−1)/2 training combinations may be generated as described in FIG. 13.

Method 1200 thus implements the critical conversion of the validated patterns to multi-dimensional relationship vectors for each entity pair, Raw metadata patterns are transformed into structured, normalized, multi-dimensional numerical representations that capture temporal, behavioral, frequency, and channel characteristics of entity relationships. These vectors enable both relationship strength scoring (for qualification filtering) and exponential training data generation (by providing the rich feature representations that populate training combinations).

The privacy-preserving nature of method 1200 is maintained throughout, as all processing operates exclusively on metadata without accessing communication content, ensuring compliance with privacy regulations while enabling sophisticated relationship analysis and training data generation.

Method 1200 transforms raw metadata patterns into multi-dimensional relationship vectors, producing standardized dimensional representations (temporal, behavioral, frequency, channel dimensions) for each discovered pattern. Method 1300 (FIG. 13) accepts these vectors and generates exponential training data multiplication within single domains. The dimensional standardization performed in FIG. 12 enables FIG. 13 to apply consistent pattern generation algorithms regardless of metadata source domain.

FIG. 13 is a flow diagram of an example method 1300 for exponential training data generation, according to an embodiment of the invention. Method 1300 may be executed by processor 511 in coordination with different components of the communication management server 506 by executing instructions stored in memory 512. These instructions, stored in non-transitory computer-readable memory and executed by one or more processors, enable the exponential training data generation process 1300 that transforms n entities into n (n-1)/2 training data combinations through relationship-based processing.

At step 1302, method 1300 begins with receiving entity interaction data from a plurality of entities across multiple communication channels. The system receives entity interaction data that includes communications between entities operating in healthcare, financial services, education, e-commerce, and social media domains. Entity interaction data encompasses all forms of digital communications including emails, text messages, voice calls, video conferences, instant messages, and social media interactions that occur between entities through the communication management system. The system captures interaction data without accessing communication content, focusing exclusively on metadata patterns that preserve privacy while enabling relationship analysis.

At step 1304, pattern analysis engine 536 may extract and analyze metadata from the entity interaction data. Pattern analysis engine 536 may identify timing patterns, frequency distributions, response latencies, and behavioral characteristics without accessing communication content. Pattern identification utilizes machine learning algorithms, statistical analysis, and behavioral modeling techniques to extract meaningful relationship insights from communication metadata.

Pattern analysis engine 536 may analyze the extracted metadata to discover underlying relationship patterns, communication behaviors, temporal trends, and interaction characteristics that define entity relationships. The extracted metadata patterns may include, but is not limited to, temporal patterns, behavioral patterns, frequency patterns, and channel patterns.

Temporal patterns my capture timing patterns including temporal sequences of communications, peak interaction periods, communication duration patterns, and seasonal or cyclical interaction behaviors, response timing patterns indicating communication urgency and priority and time-of-day preferences showing contextual communication habits.

Behavioral patterns capture entity interaction characteristics including, but not limited to, communication initiation patterns (which entity typically initiates contact), reciprocity patterns (measuring balanced versus one-sided interactions), engagement depth patterns (level of interaction complexity), interaction consistency (relationship stability), behavioral synchronization indicators (coordinated communication behaviors), and communication style patterns (formality, urgency, and interaction modes).

Frequency patterns capture interaction rate characteristics including, but not limited to, communication frequency rates measuring contacts per time period, interaction consistency measures showing regularity of contact, communication volume patterns revealing relationship intensity, and cadence patterns showing rhythmic interaction patterns, trend patterns indicating increasing, stable, or decreasing interaction rates, and burst patterns revealing concentrated communication periods.

Channel patterns capture communication medium preferences including, but not limited to, preferred communication channels (email, voice, text, video) for different contexts, channel switching patterns (multi-modal communication behaviors), channel diversity, context-specific channel selection (revealing situational preferences), and channel consistency patterns.

Pattern analysis engine 536 may ensure privacy preservation through metadata-only processing. Pattern analysis engine 536 does not access message content or body text, email subject lines or content, voice call transcriptions, document contents, or image or video content. Pattern analysis engine may process timestamps: to identify different patterns.

For example, metadata patterns may be identified using timestamps (For example, UNIX epoch times), duration (in seconds), frequency (events per time unit), channel identifiers (For example, 1=email, 2=phone, 3=SMS), response latency (time between receipt and response), and interaction sequences (For example, A→B→A communications).

This metadata-only approach ensures compliance with regulation set by General Data Protection Regulation (GDPR) and California Consumer Privacy Act (CCPA) while generating rich training data.

In an embodiment, pattern analysis engine 536 may identify seven-dimensional relationship patterns including temporal patterns that capture timing and scheduling behaviors, frequency patterns that measure communication consistency, latency patterns that analyze response behaviors, channel patterns that determine communication preferences, initiation patterns that identify communication leadership roles, synchronization patterns that measure behavioral alignment, and trust patterns that assess relationship reliability and consistency. These seven-dimensional patterns form the basis for subsequent multi-dimensional relationship vector generation, where each dimension contributes to the comprehensive representation of entity relationships. It must be understood that the seven-dimensions relationship pattern is an example, any number of relationships patterns may be considered.

At step 1306, processor 511 may compute a pattern confidence score for each individual patterns score to quantify the reliability and statistical significance of the identified patterns. Pattern confidence scoring assesses data completeness by verifying that sufficient metadata fields are populated for reliable analysis. Pattern confidence scoring assessment considers temporal consistency (communication patterns demonstrate stability over time) and behavioral coherence (identified patterns align with expected relationship characteristics)

In an embodiment, a multi-factor evaluation may be implemented based on data completeness, temporal consistency, and behavioral coherence. These three factors are computed and combined to determine a confidence score for each individual pattern.

Data completeness is an assess of whether sufficient metadata exists to establish the specific pattern as statistically significant, considering factors such as the number of observations and pattern repetitions. Patterns with broader evidence and multiple instances receive higher completeness scores. Data completeness evaluation examines metadata field population rates, minimum observation thresholds, pattern repetition counts, and temporal coverage spans to ensure statistical validity. In an embodiment, data completeness (DC) may be calculated as below:

$$D C = ( 0.4 \times MetadataFieldRatio ) + ( 0.35 \times ObservationRatio ) + ( 0.25 \times RepetitionRatio )$$

$$Where MetadataFieldRatio = Populated\_fields / 5 ( capped at 1. ) and the five required fields : timestamp , \\ channel\_type , duration , sender\_id , receiver\_id ] ,$$

$$ObservationRatio = min ( 1. , observation\_count / 5 ) [ Pattern requires minimum 5 observations ] , and$$

$$RepetitionRatio = min ( 1. , repetition\_count / 3 ) [ Pattern must repeat minimum 3 times ]$$

Result: DC ranges from 0.0 to 1.0

Temporal consistency measures whether the specific pattern remains stable across different observation periods. Pattern analysis engine 536 may analyze how consistently the pattern appears over time, with stable patterns receiving higher consistency scores than those showing high variability. Temporal consistency analysis evaluates pattern stability across multiple time windows, variance in pattern characteristics over time, deviation from expected temporal distributions, and consistency of pattern appearance across different contexts. In an embodiment, temporal consistency (TC) may be calculated using the formula below:

$$T C = 1. - min ( 1. , Standard\_Deviation / Mean )$$

Where the measurements are all individual pattern occurrences, Mean is the average of all measurements, and

$$Standard\_Deviation = sqrt ( \sum ( {( x\_i - Mean )}^{2} ) ) / count$$

Consider an example: Response times [60, 65, 58, 62, 61] minutes

$$Mean = 61 , StdDev = 2.32 , T C = 1. - ( 2.32 / 61 ) = 0.962$$

Result: TC ranges from 0.0 (highly variable) to 1.0 (perfectly consistent)

Behavioral coherence determines whether the pattern demonstrates characteristics that align logically with expected relationship dynamics for its category. Patterns showing coherent, contextually appropriate behaviors receive higher coherence scores. Behavioral coherence assessment validates that patterns align with known relationship models, conform to domain-specific behavioral expectations, demonstrate logical consistency with related patterns, and exhibit characteristics appropriate for the relationship context. In an embodiment behavioral coherence (BC) may be computed using below formula:

$$B C = Pearson\_Correlation ( PredictiveBehavior , ActualBehavior )$$

Where ActualBehavior is the observed patterns from entity interaction data, PredictedBehavior is the expected behavior from similar relationships in database, and where the correlation uses standard Pearson formula.

$$If correlation < 0 , set B C = 0. ( reject negative correlations )$$

Result: BC ranges from 0.0 to 1.0

These three evaluation components may be combined using weighted algorithms to generate a confidence score for each individual pattern, normalized to a 0.0-1.0 scale. The weighting adjusts based on pattern type and relationship context. For example, temporal consistency might receive higher weighting for professional relationship patterns, while behavioral coherence might be weighted more heavily for personal relationship patterns. In an example,

$$Pattern\_Confidence \_Score = ( 0.4 \times D C ) + ( 0.35 \times T C ) + ( 0.25 \times B C )$$

Quality Threshold: PCS≥0.70
Patterns scoring≥0.70 proceed to entity pair identification
Patterns scoring<0.70 are logged for analysis and discarded

The domain-specific weight adjustments may be as below:
Healthcare: w1=0.30, w2=0.30, w3=0.40 (emphasize behavioral coherence)
Finance: w1=0.35, w2=0.45, w3=0.20 (emphasize temporal consistency)
Education: w1=0.45, w2=0.30, w3=0.25 (emphasize data completeness)
E-commerce: w1=0.40, w2=0.35, w3=0.25 (balanced)
Social media: w1=0.30, w2=0.50, w3=0.20 (emphasize temporal consistency)

When a domain identifier matches domain-specific configuration then domain-specific weights are applied and when the domain identifier does not match the domain-specific configuration universal default weights (0.40, 0.35, 0.25) are applied.

At step 1308, pattern analysis engine 536 may determine whether the pattern confidence score exceeds a quality threshold. In an embodiment, the quality threshold may be user configurable and may be set between 0.6 and 0.9 depending on application requirements. Higher quality thresholds (0.8-0.9) may be used for critical applications requiring maximum reliability, while lower thresholds (0.6-0.7) may enable broader pattern inclusion for exploratory analysis or data-rich environments where pattern volume compensates for individual pattern uncertainty.

At step 1308, when the pattern confidence score falls below the quality threshold, method 1300 proceeds to step 1310 where the pattern data may be stored in a log for analysis. Low-confidence patterns are logged for system improvement, pattern analysis refinement, and threshold optimization. This logging process enables continuous improvement of pattern recognition algorithms and helps identify communication scenarios that require enhanced metadata processing capabilities.

At step 1308, when the pattern confidence score meets or exceeds the quality threshold, then at step 1311, pattern analysis engine 536 may identify qualified entity pairs from validated patterns that exceed the quality threshold. The validated patterns are metadata patterns that exceed the quality threshold at step 1308. This step associates validated metadata patterns with specific entity pairs that generated these patterns through their interactions. Pattern analysis engine 536 may determine which entities are connected by each validated pattern and groups related patterns by entity pairs to create a relationship context for each pair.

This entity pair identification process creates the foundation for relationship scoring by establishing which specific entities will receive multi-dimensional relationship vectors. The identification process ensures that each entity pair represents a distinct relationship with sufficient validated pattern evidence to support meaningful relationship scoring. Entity pairs are formed based on communication metadata that shows interaction between the entities, creating explicit relationship candidates that proceed to the scoring process. This step transforms pattern-level validation into entity-pair-level processing, establishing the relationship units that will receive scoring, strength evaluation, and eventual combination generation.

At step 1312, relationship scoring engine 552 may convert validated patterns to multi-dimensional relationship vector. The conversion process transforms validated metadata patterns into multi-dimensional relationship vectors through a structured methodology that extracts features from patterns, normalizes them across communication contexts, and organizes them into dimensional categories.

The conversion process transforms validated metadata patterns into multi-dimensional numerical affinity scores through relationship scoring methodology. Each entity pair receives a multi-dimensional relationship vector comprising temporal score (0.0-1.0), frequency score (0.0-1.0), latency score (0.0-1.0), channel score (0.0-1.0), initiation score (0.0-1.0), synchronization score (0.0-1.0), and trust score (0.0-1.0). The process of conversion of the validated patterns into a multi-dimensional relationship score has been discussed in previous FIG. 12.

At step 1314, relationship scoring engine 552 may compute relationship strength score for entity pairs by applying weights to each dimension of the multi-dimensional relationship vector. The relationship strength score is indicative of the quality and reliability of entity relationships. Domain-specific weights may be applied to multiple dimensions and the multiple dimensions may be combined into a single aggregate score. The weighting process recognizes that different dimensions have varying predictive power for relationship quality across different application domains.

In one implementation, the relationship strength computation calculates a weighted average of the seven-dimensional numerical affinity scores, applying domain-specific weighting algorithms that emphasize the most predictive relationship dimensions for each application context. Relationship strength scoring enables the system to quantify the overall quality and reliability of entity relationships through a single metric that combines multiple relationship dimensions. The relationship strength score is calculated using the seven intermediate dimension scores:

$$Relationship\_Strength = {w}_{1} \times temporal\_score + {w}_{2} \times frequency\_score + {w}_{3} \times latency\_score + {w}_{4} \times channel\_score + {w}_{5} \times initiation\_score + {w}_{6} \times synchronization\_score + {w}_{7} \times trust\_score$$

where weights w₁ through w₇ sum to 1.0 and are adjusted based on the application domain.

In an embodiment, the computed relationship strength scores may range from 0.0 to 1.0, where higher scores indicate stronger, more reliable relationships that generate higher-quality training data for artificial intelligence systems. In an example embodiment, trust and temporal dimensions may typically receive weights (example, 0.3 and 0.25 respectively), while other dimensions receive distributed weights. These weights are configurable and can be adapted based on domain requirements, with healthcare applications potentially emphasizing trust dimensions more heavily (example, weights up to 0.4), while e-commerce applications might emphasize frequency and recency dimensions more strongly

The computed relationship strength scores may be stored in relationship fingerprints database 534 for subsequent processing and retrieval. Fingerprints database 534 may maintain the complete set of multi-dimensional vectors along with their computed strength scores, creating a persistent repository of relationship representations that supports both communication security functions and training data generation.

At step 1316, relationship scoring engine 552 may determine whether the relationship strength score exceeds a predetermined threshold. The relationship strength threshold validation step ensures that only meaningful, reliable relationships proceed to combination generation, filtering out weak or inconsistent entity interactions that would produce low-quality training data. In an example, the predetermined threshold may be set (example, 0.5) for most applications but may be configurable based on domain requirements and quality standards. Higher thresholds (example, 0.6-0.8) are used when training data quality is prioritized over volume, while lower thresholds (example, 0.4-0.5) enable larger training datasets when volume is needed and downstream filtering is available.

At step 1316, when the relationship strength score falls below the predetermined threshold, method 1300 proceeds to step 1317 where the entity pairs that do not meet strength requirements are discarded. Discarded entity pairs are excluded from training data generation to maintain overall data quality and computational efficiency. This filtering process prevents weak relationships from diluting training data quality and reduces computational load by processing only qualified entity pairs.

At step 1316, when the relationship strength score meets or exceeds the predetermined threshold, method 1300 proceeds to step 1318 where training data generator 550 may generate relationship combination data from qualifies entity pairs. The qualified entity pairs are entity pairs with the relationship strength score exceeding the predetermined threshold. The combination generation process creates all possible unique entity pairs from qualified entities while avoiding duplicate pairs and self-references. Each entity pair is associated with its corresponding multi-dimensional relationship vector and relationship strength score from the previous processing steps.

The combination generation process creates all possible unique entity pairs from qualified entities while avoiding duplicate pairs and self-references. Each entity pair is associated with its corresponding multi-dimensional relationship vectors and relationship strength score from the previous processing steps. The relationship combination data comprises a collection of qualified entity pairs, and each entry includes the entity identifiers, the complete multi-dimensional relationship vector with all its features across all dimensions, the computed relationship strength score, and contextual metadata about the relationship source and characteristics.

At step 1320, training data generator 550 uses scaler 555 to generate N(N−1)/2 training combination data from entity pairs. Each training combination data includes a multi-dimensional vector, a relationship label and a domain identifier. The training combination data generation process implements the core exponential scaling mechanism using scaler 555 to transform N qualified entity pairs into N(N−1)/2 unique training combinations. This mathematical transformation provides the exponential growth in training data that addresses the AI industry's training data scarcity problem.

In an embodiment, training data generator 550 may use specific algorithm for transforming N entities into N(N−1)/2 training combinations. First, training data generator 550 may create unique entity pairs from the qualified entities. For N qualified entities, the system generates all possible unique pairs where each entity is paired with every other entity exactly once, avoiding duplicate pairs (e.g., treating (E1, E2) and (E2, E1) as the same pair) and self-pairs (e.g., excluding (E1, E1)). This creates exactly N(N−1)/2 unique entity pair combinations.

Second, for each unique entity pair, the system may combine the multi-dimensional relationship vector with additional training-relevant information to form a complete training combination. The additional information may include a relationship label and a domain identified. Each training combination data has an associated multi-dimensional relationship vector with multiple dimensions including temporal dimensions, response latency patterns, interaction duration patterns; behavioral dimensions, initiation patterns, reciprocity patterns, communication frequency dimensions, cadence patterns, and channel preference.

In an embodiment, the relationship label provides a relationship classification between the entity pair. The relationship label indicates the type or category of relationship, which may include classifications such as professional, personal, familial, transactional, collaborative, or domain-specific relationship types. Relationship labels enable supervised learning by providing ground truth or inferred relationship categories that AI systems can learn to predict or utilize in decision-making.

In an embodiment, the domain identifier specifies the source application domain from which the entity interaction data originated. The domain identifier indicates whether the relationship data came from healthcare, financial services, education, e-commerce, social media, or other application domains. Domain identifiers enable cross-domain learning by allowing AI systems to identify patterns that generalize across domains versus those that are domain-specific

System generates N(N−1)/2 training combinations by repeating this process for all unique entity pairs. Each training combination is formatted as an AI-ready training dataset with feature vectors, target labels, and associated metadata.

Relationship combination generation implements the mathematical foundation of exponential scaling, where n qualified entities generate N(N−1)/2 unique relationship combinations. In an embodiment, training data generator 550 may use specific algorithm for transforming N entities into N(N−1)/2 training combinations as follows:

During entity metadata extraction, for each entity Ei (where i=1 to N), metadata extraction is performed. The steps of metadata extraction include:
(Extract temporal metadata: {timestamp, frequency, duration}
Extract behavioral metadata: {initiation_rate, response_time, interaction_count}
Extract channel metadata: {preferred_channel, channel_switch_count}
Store as vector Vi=[t1, t2, . . . , b1, b2, . . . , c1, c2, . . . ])

This entity-level vector Vi represents the metadata characteristics of entity Ei derived from all its interactions. Each element in Vi corresponds to a specific metadata feature, organized by dimension categories (temporal, behavioral, channel). Once the metadata is extracted a pairwise relationship generation (relationship combination data) is performed. For each unique pair (Ei, Ej) where i<j, relationship vector is calculated and transformation function is applied.

$$Rij = Vi ⊗ Vj ( element - wise operations ) , and$$

$$Tij = σ ( W \cdot Rij + b )$$

where Rij is the pairwise relationship vector combining features from both entities, −Vi⊗Vj represents element-wise operations (such as concatenation, difference, product, or learned combinations) that create relationship features from individual entity features, Tij is the transformed relationship representation, W is a learned weight matrix that maps relationship features to optimized representations, −b is a bias term, −σ is an activation function (such as ReLU, tanh, or sigmoid) that introduces non-linearity, W is a learned weight matrix, b is bias, σ is activation.

Training data is computed from the pairwise relationship combination data. For each pairwise relationship (Rij), feature vectors (F) and label (L) are generated to form the training instance (F, L)

$$F = [ Rij , domain\_label , timestamp ]$$

L=relationship_strength_score
Training instance: (F, L)
where: −F is the complete feature vector for the training combination, comprising the multi-dimensional relationship vector Rij (with multiple dimensions), the relationship label (domain_label indicating the relationship classification), and the domain identifier (indicating source domain), along with temporal context (timestamp), L is the target label, which in this example uses the relationship strength score as the learning target, though other labels could be used depending on the AI system's learning objective, training combination (F, L) represents one complete training data point ready for consumption by AI systems.

Consider an example with N=10 entities with four entities E1, E2, E3, E4, E5, E6, E7, E8, E9, E10. Relationship pairs (relationship combination data) generated:
(E1,E2), (E1,E3), (E1,E4), (E1,E5), (E1,E6), (E1,E7), (E1,E8), (E1,E9), (E1,E10) (E2,E3), (E2,E4), (E2,E5), (E2,E6), (E2,E7), (E2,E8), (E2,E9), (E2,E10) (E3,E4), (E3,E5), (E3,E6),
(E3,E7), (E3,E8), (E3,E9), (E3,E10) (E4,E5), (E4,E6), (E4,E7), (E4,E8), (E4,E9), (E4,E10) (E5,E6), (E5,E7), (E5,E8), (E5,E9), (E5,E10) (E6,E7), (E6,E8), (E6,E9), (E6,E10) (E7,E8), (E7,E9), (E7,E10) (E8,E9), (E8,E10) (E9,E10)
Total: 10 (10−1)/2=45 training points

In comparison to traditional training data approach where ten relationship pairs generate ten data points, training data generator 550 creates forty-five training points. This is an exponential increase in the number of training points. Each training combination data includes a multi-dimensional vector with multiple dimensions, relationship label and domain identifier.

Consider the use case of a personalized patient communication AI with 550 entities. The number of training points is:

$$Training points : N ( N - 1 ) / 2 = 550 ( 549 ) / 2 = 151 , 425 training points$$

In another example, 1,000 qualified entities generate 499,500 relationship combinations, compared to 1,000 individual training data points in traditional linear approaches. This exponential scaling provides orders of magnitude more training data from the same entity population, addressing training data scarcity while maintaining data quality through relationship-based processing.

The N(N−1)/2 training combination generation produces exponentially more training data points than traditional approaches, enabling AI systems to learn from communication patterns rather than individual entity characteristics. Training data includes all necessary information for artificial intelligence systems to learn relationship intelligence, pattern recognition, and cross-domain compatibility through relationship-based processing methodologies.

At step 1322, fidelity enhancer 556 may enhance training quality using epistemic fidelity characteristics. The fidelity enhancement process applies four distinct fidelity characteristics to the training combination data, transforming basic relationship vectors into training data with optimal epistemic fidelity for AI learning. Each fidelity characteristic enhances specific aspects of the training data to create representations that enable sophisticated AI learning outcome. Fidelity characteristics may include quantifiable data quality metrics including, but not limited to temporal fidelity, behavioral coherence, symbolic representation score, and contextual adaptation matrix.

In an embodiment, fidelity enhancer 556 may analyze temporal evolution patterns within relationship combinations to create temporally layered information that captures how relationships develop and change over time. Temporal layering creates multi-scale temporal representations that capture how relationships develop and change across different time horizons. This fidelity characteristic recognizes that relationships exhibit different characteristics when viewed at different temporal scales, with short-term patterns revealing immediate interaction dynamics, medium-term patterns showing relationship evolution, and long-term patterns demonstrating sustained relationship characteristics. In an example, temporal fidelity (TF) may be computed using below formula:

$$T F = \sum ( consistent\_patterns ) / \sum ( total\_patterns )$$

where consistent patterns have minimal variance. This metric quantifies the temporal stability and consistency of patterns across different time scales, with higher TF values indicating more reliable temporal patterns in the training data

Temporal layering creates multi-scale temporal representations that capture how relationships develop and change across different time horizons. This fidelity characteristic recognizes that relationships exhibit different characteristics when viewed at different temporal scales, with short-term patterns revealing immediate interaction dynamics, medium-term patterns showing relationship evolution, and long-term patterns demonstrating sustained relationship characteristics

In an embodiment, fidelity enhancer 556 may extract emotional resonance indicators from behavioral patterns and trust scores to identify relationship characteristics that provide optimal learning value for artificial intelligence systems. Emotional resonance enhancement creates training data that captures the affective and qualitative aspects of relationships revealed through behavioral patterns. While the system processes only metadata without accessing content, behavioral patterns such as response timing, communication frequency variations, and interaction engagement reveal emotional dimensions of relationships.

The emotional resonance enhancement incorporates these sentiment indicators, emotional valence scores, and affective communication pattern representations into the training data, creating emotionally resonant representations that achieve temporal correlation between emotional patterns (inferred from metadata) and communication behaviors. A high correlation ensures that the training data captures the relationship between emotional states and observable communication patterns, enabling AI systems to understand and predict emotionally-informed behaviors

In an example, a Behavioral Coherence (BC) may be computed using below formula:

$$B C = correlation\_coefficient ( predictive\_behavior , actual\_behavior )$$

A high correlation coefficient is indicative of high fidelity.

In an embodiment, fidelity enhancer 556 may generate symbolic richness through contextual pattern analysis across multiple communication channels, enabling AI systems to understand relationship nuances and contextual variations. Symbolic richness enhancement extracts abstract, semantic representations from the concrete metadata patterns, creating training data that contains rich symbolic features enabling sophisticated pattern recognition. While metadata patterns provide numerical values, symbolic richness transforms these into higher-level semantic features that capture the meaning and context of communication patterns.

A symbolic representation score (SRS) may be generated using pre-trained embeddings from BERT/Word2Vec.

$$S R S = embedding\_similarity ( metadata\_vector , semantic\_space )$$

The generation of epistemic fidelity characteristics ensure that training data is emotionally resonant, temporally layered, symbolically rich, and contextually adaptive, providing artificial intelligence systems with training data that captures the depth and complexity necessary for advanced learning outcomes. Enhanced training data through epistemic fidelity processing enables AI systems to develop more sophisticated understanding of communication patterns and contextual intelligence.

In an embodiment, fidelity enhancer 556 may apply contextual adaptivity by incorporating environmental factors, situational relationship contexts, and domain-specific relationship characteristics into training data enhancement. Contextual adaptivity enhancement creates training data capable of adapting to different contexts by encoding environmental factors, situational variables, and dynamic adjustment parameters. This fidelity characteristic recognizes that relationships exhibit different patterns in different contexts, and effective AI systems must account for these contextual variations.

The generation of epistemic fidelity characteristics ensure that training data is emotionally resonant, temporally layered, symbolically rich, and contextually adaptive, providing artificial intelligence systems with training data that captures the depth and complexity necessary for advanced learning outcomes. Enhanced training data through epistemic fidelity processing enables AI systems to develop more sophisticated understanding of communication patterns and contextual intelligence.

The combination of all four fidelity characteristics creates training data with optimal epistemic fidelity. Emotional resonance enables AI systems to understand affective dimensions of relationships. Temporal layering (across multiple time scales) enables AI systems to reason about both immediate and long-term relationship dynamics. Symbolic richness (with >twenty semantic features) enables sophisticated pattern recognition and relationship understanding. Contextual adaptivity (through context vectors and adjustment parameters) enables context-aware AI decision-making.

Training data enhanced with these fidelity characteristics substantially improves AI system performance across multiple domains by providing representations that capture the full complexity of human relationships while maintaining privacy through metadata-only processing.

At step 1324, the enhanced training data is delivered to AI systems for learning and inference. The training data delivery process may implement adaptive selection between model-based reinforcement learning using Markov Decision Processes and model-free reinforcement learning using neural networks based on context evaluation, data availability, and computational requirements.

The exponential training data generation method 1300 demonstrates converting linear entity processing into exponential relationship-based training data generation. The process implements privacy-preserving metadata-only processing while generating training data characterized by optimal epistemic fidelity for enhanced artificial intelligence learning effectiveness. The mathematical transformation from n entities to N(N−1)/2 training combinations provides the exponential scaling advantage that addresses training data scarcity while maintaining privacy and quality standards.

### Organic Training Data Growth Through Temporal Evolution

Organic training data growth refers to the continuous increase in the quantity and quality of training data generated from existing relationships without requiring external data acquisition or new entity addition. As relationships between entities mature and evolve over time through ongoing interactions, the system observes how communication patterns change, behavioral characteristics develop, and trust deepens. These observations are captured in updated relationship vectors, which are then used to regenerate training combinations with increasing quality.

The same set of entities (e.g., 100 entities creating 4,950 training combinations) generates progressively more valuable training data simply through the passage of time and continued interaction—without ever adding a new entity to the system. As relationships mature over time through ongoing interaction, the multi-dimensional relationship vectors become enriched with temporal, behavioral, and contextual depth. This ongoing temporal evolution provides opportunity for continuous improvement of training data quality without requiring acquisition of new entities.

In an embodiment, the temporal evolution may be used to calculate different parameters including, but not limited to, updated multi-dimensional vectors, quality multiplication factor (QMF), and organic growth rate (OGR).

When a relationship vector is updated through new interaction data, the system calculates the difference (delta) between the previous vector state and the new vector state. This delta represents new training data generated by the evolution of the relationship. For example:

$$Day 1 : Relationship vector V = [ temporal\_ 0 , behavioral\_ 0 , frequency\_ 0 , channel\_ 0 ]$$

$$Day 31 : Relationship vector {V}^{′} = [ temporal\_ 1 , behavioral\_ 1 , frequency\_ 1 , channel\_ 1 ]$$

$$Delta = {V}^{′} - V = new training data generated by relationship evolution$$

$$Temporal Ecolution Contribution ( T E C ) = Sum ( all deltas ) / 30 = training combinations per day from evolution$$

As relationships continue to interact, this temporal evolution contribution accumulates, continuously adding new training data. Older relationships produce higher-quality training data than younger relationships. A six-month relationship has more stability and depth than a one-month relationship. A two-year relationship demonstrates relationship resilience and trust development not visible in new relationships.

In an embodiment, training data generator 550 may compute QMF based on relationship age. For example,

$$1 - month relationship \text{:} QMF = 1. \times ( baseline )$$

$$6 - month relationship \text{:} QMF = 1.5 \times ( temporal layering demonstrates stability )$$

$$12 - month relationship \text{:} QMF = 2. \times ( behavioral evolution patterns clear )$$

$$24 - month relationship \text{:} QMF = 2.5 \times ( emotional resonance and trust maturity evident )$$

This multiplier reflects the observed increase in training data quality as relationships mature. The same N(N−1)/2 combinations, when regenerated from older, more mature relationships, contain richer, more nuanced, more stable relationship signals.

In an embodiment, training data generator 550 may compute OGR as below:

$$O G R = ( Sum of T E C across all relationships \times Average Q M F / Time Period$$

Units: Training combinations per unit time

This measures how much new, valuable training data is generated purely from the temporal evolution of existing relationships, with zero requirement for external data acquisition. As relationships interact, the N(N−1)/2 combinations are continuously regenerated with updated, enriched relationship vectors. Each regeneration includes the accumulated temporal evolution, producing training combinations of increasing quality.

This creates a form of compound value growth:

$$Month 1 \text{:} 100 entities \to N ( N - 1 ) / 2 = 4 , 950 combinations , quality level Q 1$$

$$Month 6 \text{:} SAME 100 entities \to 4 , 950 combinations , quality level Q 1.5 ( due to temporal evolution )$$

$$Month 12 \text{:} SAME 100 entities \to 4 , 950 combinations , quality level Q 2.$$

The deployment becomes more valuable over time, not less. Older deployments are more valuable than newer deployments, because the same relationships have had more time to mature and evolve.

In an embodiment, communication management server 506 may continuously monitor organic growth rate against target thresholds. When organic growth rate falls below target (indicating slowing temporal evolution), the system triggers stimulation mechanisms. The stimulation mechanisms may include, but are not limited to, enhancing fidelity parameters, adjusting temporal window, and dimensional reweighing.

Enhancing of fidelity parameters may increase the sensitivity of temporal layering analysis to capture more granular relationship development patterns. Temporal window adjustment includes modifying the time windows over which temporal evolution is measured, potentially capturing patterns that manifest over different time scales. Dimensional reweighting shifts emphasis toward dimensions showing strongest evolution, maximizing the training data richness extracted from ongoing interactions. These mechanisms automatically increase the organic growth rate until it exceeds target thresholds, creating a self-improving, adaptive system that optimizes the value extracted from existing relationships.

These temporal characteristics are captured as fidelity characteristics (temporal layering, behavioral evolution, contextual adaptivity, emotional resonance) that only emerge when the system observes relationships over extended periods.

Method 1300 generates exponentially multiplied training data within a single application domain, producing high-confidence relationship patterns validated through iterative dimensional reduction and pattern validation cycles. These validated patterns, along with their dimensional characteristics (temporal dimensions, behavioral indicators, frequency measures, and channel specifications) constitute the primary source data for cross-domain pattern transfer

FIG. 14 is an example flow diagram depicting the temporal evolution of relationship between entities, according to an embodiment of the invention. FIG. 14 demonstrates how a relationship vector evolves across three distinct time points and how the system regenerates training combinations with increasing quality as the relationship matures.

FIG. 14 shows the temporal evolution of a single entity relationship across three time points 1402 (T1 at 1 month), 1404 (T2 at 6 months), and 1406 (T3 at 12 months). At each time point, the diagram illustrates the updated multi-dimensional relationship vector [temporal, behavioral, frequency, channel] capturing the evolved relationship characteristics, corresponding Quality Multiplication Factor (QMF) computed based on relationship age (1.0× at 1 month, 1.5× at 6 months, 2.0× at 12 months) and the regenerated N(N−1)/2 training combinations with quality-enhanced metadata reflecting the relationship's evolution, and the resulting training combination quality level [Q1→Q1.5→Q2.0]

The progression from different time points (1402 to 1404 to 1406) demonstrates that the same entity pair generates increasingly valuable training data as the relationship matures through continued interaction, without requiring any new entity acquisition or external data sources. The vector evolution [V1→V2→V3] captures how temporal layering, behavioral evolution patterns, and contextual adaptivity accumulate over time, producing training data with superior epistemic fidelity.

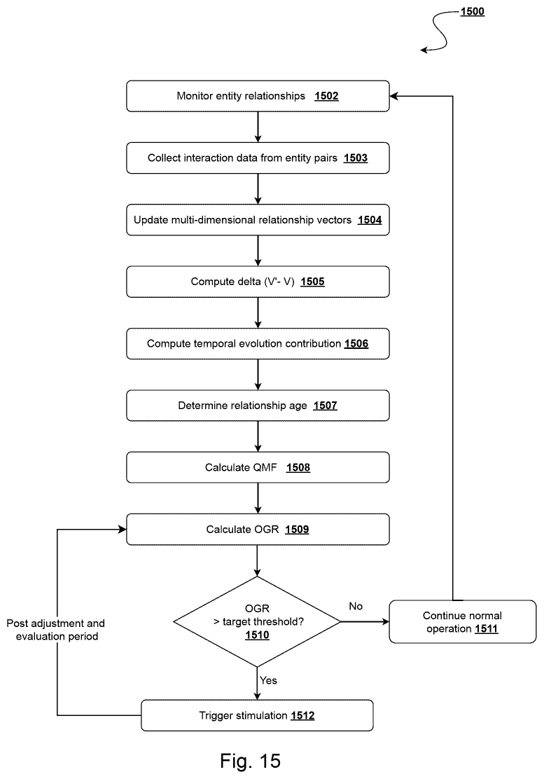

FIG. 15 is an example flow diagram 1500 depicting the organic growth rate (OGR) calculation and adaptive monitoring method according to an embodiment of the invention. FIG. 15 illustrates the continuous operational cycle through which communication management server 506 monitors, measures, and optimizes organic training data growth through responsive stimulation mechanisms. The method steps described in the organic training data growth process are performed by processor 511 working in coordination with multiple specialized components within communication management server 506. Rather than executing all operations sequentially in a single monolithic unit, processor 511 orchestrates the workflow by delegating specific computational tasks to specialized components, each optimized for their particular function. This distributed architecture enables efficient parallel processing, scalability to large datasets, and clear separation of concerns where each component maintains responsibility for its specialized domain.

Method begins at step 1502 with monitoring of entity relationships. Processor 511 coordinates with pattern analysis engine 536 to continuously monitor entity interaction metadata flowing through communication management server 506. The system continuously observes interactions between entity pairs across multiple communication domains.

At step 1503, processor 511 may instruct pattern analysis engine 536 to collect interaction data including timestamps, communication channels, response times, interaction duration, and frequency patterns from the interaction graph 520. No communication content is accessed or processed.

At step 1504, processor 511 may signal relationship scoring engine 552 to update multi-dimensional relationship vectors based on the newly collected interaction metadata. The system updates multi-dimensional relationship vectors based on the new interaction data. Each relationship vector is enriched with temporal, behavioral, frequency, and channel dimensions that reflect the evolved state of the relationship.

At step 1505, relationship scoring engine 552 may compute the vector delta (V′−V) representing the difference between previous and current vector states, and transmits the updated vectors and delta values back to processor 511. At step 1505, the system computes delta (Δ) representing the difference between the previous relationship vector state and the updated vector state: Delta=V′−V. This delta represents new training data generated by the relationship's evolution.

At step 1506, processor 511 may receive delta values from relationship scoring engine 552 and coordinates with training data generator 550 to compute Temporal Evolution Contribution (TEC) by summing all deltas across all relationships within the measurement period:

$$TEC = Sum ( all deltas ) / Time Period .$$

Training data generator 550 maintains running TEC calculations and provides periodic summary reports to processor 511.

At step 1507, processor 511 may accesses relationship fingerprints database 534 to determine the age of each entity pair relationship, measuring the duration from initial relationship formation to the current measurement cycle. This age determination is performed by querying the relationship metadata stored in database 534 and computing elapsed time.

At step 1508, processor 511 receives relationship age information and instructs training data generator 550 to calculate the Quality Multiplication Factor (QMF) as a function of relationship age using the non-linear scaling function (1.0× at 1 month, 1.5× at 6 months, 2.0× at 12 months, 2.5× at 24 months). Training data generator 550 applies the QMF formula to each relationship and provides QMF values back to processor 511.

At step 1509, processor 511 coordinates with OGR calculator 562 to compute the Organic Growth Rate (OGR). OGR calculator 562 performs the mathematical computation using TEC values from training data generator 550 and QMF values computed in the previous step, returning the current OGR measurement to processor 511.

In an embodiment, OGR is the quantitative measurement of how much new, valuable training data is being generated from relationship evolution during a specific time period. Rather than counting raw data points, OGR measures the accumulation of temporal evolution contributions (TEC) weighted by relationship quality multipliers (QMF), expressed as training combinations per unit time.

$$OGR = ( Sum of TEC across all relationships \times Average QMF ) / Time Period .$$

Units: Training combinations per unit time (per day, week, or month)

At step 1510, processor 511 compares the calculated OGR against a target threshold.

In an embodiment, the target threshold may be a configurable target threshold that is dynamically adjustable based on system deployment characteristics (size of entity base, domain type, relationship density), historical OGR performance (thresholds increased when system consistently exceeds previous targets), external factors (seasonal variations in entity interaction patterns, domain-specific relationship cycles). Processor 511 may periodically recalculate the target threshold and adjusts the comparison criteria.

At step 1510, if OGR meets or exceeds the target threshold, then at step 1511, processor 511 permits the training data generation pipeline to continue at current parameter settings. Processor 511 instructs training data generator 550 and fidelity enhancer 556 to maintain current operations, continuously regenerating N(N−1)/2 combinations with evolved vectors and quality-enhanced QMF multipliers. Data export interface 558 continues delivering training data to external AI systems. Method 1500 loops back to step 1502 (shown by the feedback arrow) to monitor entity relationships with the new adjusted parameters.

At step 1510, if OGR is below the target threshold, then at step 1512, processor 511 signals adaptive parameter controller 560 to execute stimulation mechanisms. In an embodiment, adaptive parameter controller 560 may signal fidelity enhancer 556 to increase the sensitivity of temporal layering analysis, adjusting sensitivity from 1.0× (baseline) to 5.0× (maximum granularity). This adjustment enables fidelity enhancer 556 to detect more granular relationship development patterns in the next processing cycle.

In an embodiment, adaptive parameter controller 560 may signal training data generator 550 to modify the time windows over which temporal evolution is measured. Temporal windows are adjusted from 15-day windows (micro-patterns) to 365-day windows (macro-patterns), enabling training data generator 550 to capture patterns that manifest over different time scales in subsequent TEC calculations.

In an embodiment, adaptive parameter controller 560 may signal training data generator 550 to shift dimensional emphasis toward dimensions showing strongest evolution. Dimensional weighting is adjusted per dimension, ranging from 0.1× (minimal emphasis) to 2.0× (maximum emphasis), enabling training data generator 550 to emphasize strongly-evolving dimensions and de-emphasize stagnant dimensions in subsequent vector regeneration and combination generation.

After executing these parameter adjustments, adaptive parameter controller 564 logs the adjustment details (timestamp, parameter adjusted, adjustment magnitude, OGR measurement before adjustment) to memory 512 for historical tracking and effectiveness analysis

OGR enables the system to detect when organic growth is slowing (falling below a target threshold). When this happens, adaptive stimulation mechanisms automatically adjust system parameters—increasing fidelity sensitivity, modifying temporal windows, or reweighting dimensions—to accelerate relationship evolution and restore OGR to target levels. This creates a self-improving system that maintains optimal training data generation without manual intervention.

### Post Adjustment and Evaluation Period

In an embodiment, after stimulation adjustment, processor 511 may permit a configurable evaluation period (recommended: 7 days) to elapse, during which the training data generation pipeline operates with the newly adjusted parameters. The system re-measures OGR after a configurable evaluation period (recommended: 7 days) to determine if the stimulation adjustment succeeded in bringing OGR above target. During this period pattern analysis engine 536 continues collecting interaction data, relationship scoring engine 552 updates vectors with the new dimensional weighting, training data generator 550 regenerates combinations using the modified temporal windows, fidelity enhancer 556 applies the increased sensitivity to temporal layering analysis.

After evaluation period, processor 511 may instruct OGR calculator 562 to remeasure the OGR using the data generated under the new parameter settings. The new OGR measurement is returned to processor 511 for comparison against the target threshold.

If new OGR≥target threshold: Stimulation was successful. Processor 511 logs the effective adjustment to memory 512 and permits normal operation to continue with the new parameter settings. The system has learned which adjustment mechanism was effective for this particular OGR decline pattern.

If new OGR still <target threshold: Stimulation may require escalation. Processor 511 may trigger adaptive parameter controller 560 to execute the next stimulation mechanism (e.g., if fidelity enhancement was applied, temporal window adjustment is now applied), repeating the evaluation cycle.

If new OGR significantly exceeds target, processor 511 may signal adaptive parameter controller 560 to reduce adjustment magnitudes, returning parameters toward baseline while maintaining the improvements that exceeded the target.

The process loops continuously, with processor 511 monitoring OGR, making threshold comparisons, orchestrating component activities, and directing adaptive parameter controller 560 to maintain optimal training data generation indefinitely.

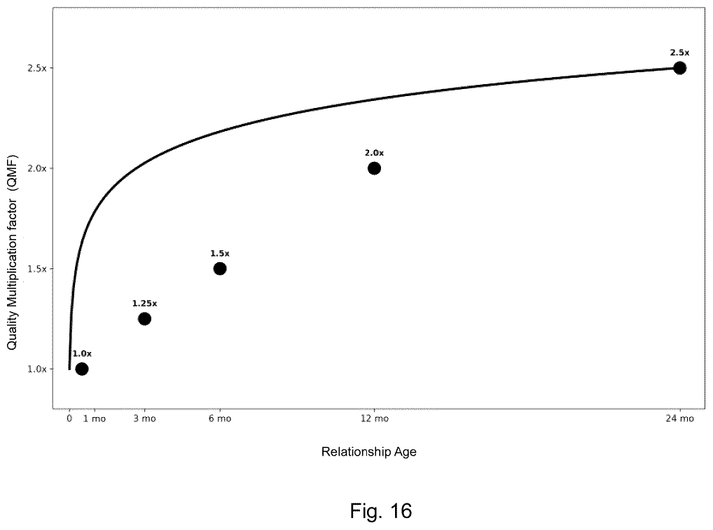

FIG. 16 is an exemplary graph depicting the Quality Multiplication Factor (QMF) as a function of relationship age, according to an embodiment of the invention, according to an embodiment of the invention. The horizontal axis (X-axis) represents relationship age, measured in months from initial relationship formation (0 months to 24 months and beyond). The vertical axis (Y-axis) represents the QMF value, measured in multipliers from 1.0× (baseline) to 2.5× and higher. FIG. 16 illustrates the non-linear scaling relationship between relationship duration and training data quality improvement:

At 1 month (1.0×QMF): Baseline quality level. Newly formed relationships contain limited temporal, behavioral, and contextual information.

At 3 months (approximately 1.25×QMF): Early temporal layering becomes observable. Communication patterns demonstrate initial stability across multiple interaction cycles.

At 6 months (1.5×QMF): Temporal layering demonstrates measurable stability. Behavioral evolution patterns emerge showing how entities adapt and evolve their interaction patterns. The system observes relationship rhythm, communication preferences, and behavioral consistency not visible in younger relationships.

At 12 months (2.0×QMF): Behavioral evolution patterns are clear and statistically significant. Long-term relationship patterns become apparent, including seasonal variations, trust development cycles, and deepened contextual understanding of relationship dynamics.

At 24 months (2.5×QMF): Deep engagement level. Emotional resonance and trust maturity are evident. The system has observed complete relationship cycles, trust development progression, and evolved interaction patterns. Relationships demonstrate resilience through challenges and contextual adaptivity across diverse scenarios.

Beyond 24 months (2.5x+QMF): Relationships continue to generate progressively higher QMF values as additional temporal depth, emotional resonance maturity, and behavioral pattern complexity accumulate.

The non-linear curve demonstrates that training data quality improvements accelerate initially (steep curve from 1-6 months) and then stabilize at higher relationship ages (flatter curve from 12-24+ months). This reflects the reality that early relationship observation captures rapid behavioral establishment and pattern formation, while later observation captures refinement and stability of established patterns. The QMF curve directly supports the system's claim that older relationships produce higher-quality training data than younger relationships, without requiring any external data acquisition or supplementary entity addition.

FIG. 17 is a flow diagram of an example method 1700 for adaptive training data delivery approach selection, according to an embodiment of the invention. Method 1700 may be executed by processor 511 in coordination with ASF 510 and data export interface 558 by executing instructions stored in memory 512. These instructions, stored in non-transitory computer-readable memory and executed by one or more processors, enable the initial selection between model-based reinforcement learning and model-free reinforcement learning delivery approaches based on state model availability.

At step 1701, method 1700 begins with receiving entity interaction data from a plurality of entities. Communication management server 506 generates N(N−1)/2 training combination data including multi-dimensional relationship vectors, relationship labels, and domain identifiers. The training combination data is generated through the exponential training data generation process described in FIG. 13. N qualified entities produce N(N−1)/2 unique training combinations. Each training data includes a multi-dimensional relationship vector capturing temporal, behavioral, frequency, and channel characteristics of the entity relationship, a relationship label classifying the relationship type and strength, and a domain identifier indicating the application domain (healthcare, financial services, education, e-commerce, or social media) from which the relationship data originated.

At step 1702, a state model detector 567 may determine whether defined state models with transition probabilities are available for the current training context. State model detector 567 analyzes the training combination data to assess whether the relationship patterns exhibit sufficient structure and consistency to support explicit state model construction. The determination considers whether relationship states can be clearly defined, whether transition dynamics between states are observable and consistent, whether reward functions can be meaningfully specified for relationship optimization objectives, and whether the state space complexity is tractable for dynamic programming approaches.

At step 1702, when it is determined that defined state models with transition probabilities are available, method 1700 proceeds to step 1703 to utilize model-based delivery. At step 1703, data export interface 558 transforms the training combination data into model-based format suitable for Markov Decision Process (MDP) consumption.

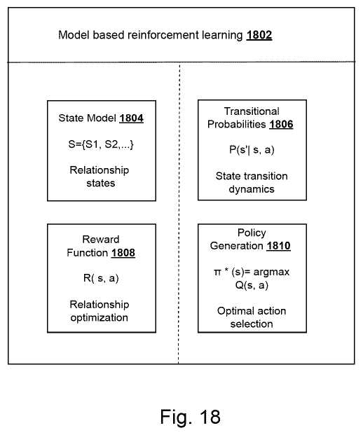

Format transformer 569 may construct the MDP representation including state definitions derived from relationship vectors, action mappings corresponding to relationship management decisions, transition probability matrices estimated from historical relationship evolution patterns, and reward functions aligned with relationship optimization objectives. The model-based delivery approach is detailed in FIG. 18.

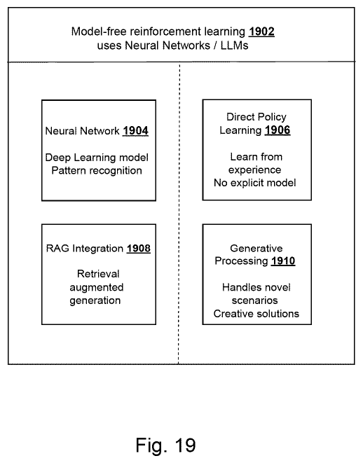

At step 1702, when it is determined that defined state models with transition probabilities are not available, method 1700 proceeds to step 1704 to utilize model-free delivery. At step 1704, data export interface 558 transforms the training combination data into model-free format suitable for neural network processing. Format transformer 569 constructs experience sequences and state-action-reward-next state (SARS) tuples that enable direct policy learning without explicit environment modeling. The model-free delivery approach is detailed in FIG. 19.

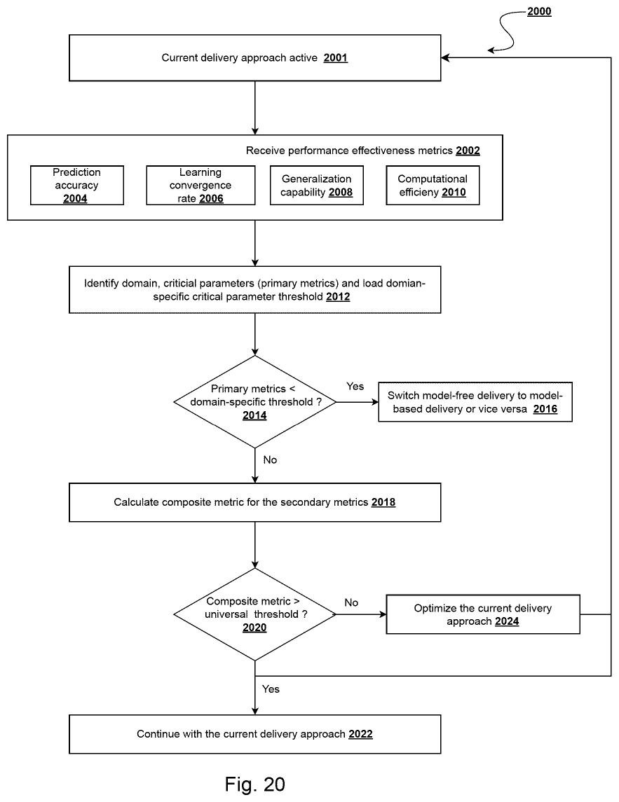

Method 1700 implements an approach for delivery based on state model availability. The simplicity of this selection reflects the recognition that the optimal initial choice may not always be apparent, and that the system's value lies in its ability to monitor performance and adaptively switch or optimize approaches when the initial selection proves suboptimal. The performance monitoring and adaptive switching functionality described in FIG. 20 enables the system to self-correct and optimize delivery approach selection through operational experience.

FIG. 18 is a block diagram illustrating the components of model-based reinforcement learning 1802 using MDP, according to an embodiment of the invention. Model-based reinforcement learning 1802 constructs explicit representations of environment dynamics that enable systematic policy optimization through dynamic programming techniques.

The model-based reinforcement learning components illustrated in FIG. 18 may be implemented using various MDP solution techniques including value iteration, policy iteration, linear programming, or Monte Carlo tree search. The choice of implementation technique is determined by state space size, computational constraints, and convergence requirements. The invention is not limited to any specific MDP solution algorithm, as the novelty lies in the adaptive selection and switching mechanism rather than the internal MDP implementation.

Model-based reinforcement learning 1802 comprises four primary components that together define the Markov Decision Process formulation. The state model S={s₁, s₂, . . . } 1804 defines the set of possible relationship states that the system can occupy. Each state represents a distinct configuration of relationship characteristics derived from the multi-dimensional relationship vectors. For relationship-based training data, states may represent different levels of relationship strength, different communication patterns, different trust levels, or different engagement intensities. The state space is constructed from discretizing or clustering the continuous relationship vector space into meaningful, distinguishable relationship configurations.

Transition probabilities P (s′|s, a) 1806 represent state transition dynamics, quantifying the likelihood of moving from current state s to next state s′ when action a is taken. For relationship-based training data, transition probabilities capture how relationships evolve over time in response to different interaction patterns. These probabilities are estimated from historical relationship evolution data, observing how entity pairs transitioned between relationship states based on communication frequency changes, channel preference shifts, temporal pattern variations, and behavioral characteristic modifications. The transition probability matrix enables the system to predict relationship evolution and optimize actions accordingly.

The reward function R(s, a) 1808 defines the objective for relationship optimization, specifying the immediate reward received when taking action a in state s. For relationship-based training data, the reward function may incentivize relationship strengthening, trust improvement, engagement increases, or other desirable relationship outcomes. The reward function translates abstract relationship optimization goals into concrete numerical signals that guide policy learning. Different application domains may employ different reward function formulations, with healthcare applications prioritizing relationship reliability and financial applications prioritizing relationship stability.

Policy generation 1810 π*(s)=argmax Q(s, a) produces optimal action selection through value function computation. The Q-function Q(s, a) represents the expected cumulative reward from taking action a in state s and following the optimal policy thereafter. Policy generation employs dynamic programming algorithms including value iteration, which iteratively updates state values until convergence, and policy iteration, which alternates between policy evaluation and policy improvement steps. The optimal policy x* maps each state to the action that maximizes expected long-term reward, providing principled decision-making guidance for relationship management.

Model-based reinforcement learning 1802 may be effective when relationship patterns exhibit consistent, predictable dynamics that can be accurately captured in transition probability estimates. Scenarios with well-defined relationship states, clear transition patterns, and stable reward structures benefit from the systematic optimization approach enabled by explicit environment modeling. The computational efficiency of dynamic programming enables rapid policy computation once the MDP components are established, making model-based delivery suitable for scenarios where state model construction is feasible and training efficiency is prioritized.

FIG. 19 is a block diagram illustrating the components of model-free reinforcement learning 1902 using neural networks, according to an embodiment of the invention. Model-free reinforcement learning 1902 learns policies directly from experience without constructing explicit environment models, utilizing deep learning architectures to approximate value functions and policies from observed interactions.

The model-free reinforcement learning components illustrated in FIG. 19 may be implemented using various neural network architectures including feedforward networks, convolutional networks, recurrent networks, transformer architectures, or hybrid combinations. The direct policy learning may employ policy gradient methods (REINFORCE, PPO, A3C), value-based methods (DQN, DDQN), or actor-critic methods (A2C, SAC, TD3). The invention is not limited to any specific neural network architecture or training algorithm, as the novelty lies in the adaptive selection and switching mechanism rather than the internal neural network implementation.

Model-free reinforcement learning 1902 comprises four primary components that together enable direct policy learning. Neural networks 1904 implement deep learning models for pattern recognition, processing multi-dimensional relationship vectors through multiple hidden layers to extract hierarchical feature representations. The neural network architecture may include convolutional layers for spatial pattern detection, recurrent layers for temporal sequence processing, attention mechanisms for relationship importance weighting, and fully connected layers for final policy or value output. Neural networks 1904 enable the system to learn complex, non-linear mappings from relationship states to optimal actions without requiring explicit state space enumeration or transition probability estimation.

Direct policy learning 1904 enables the system to learn from experience without explicit state modeling. Rather than constructing transition probability matrices and solving for optimal policies through dynamic programming, direct policy learning observes state-action-reward sequences and updates policy parameters to increase expected reward. Policy gradient methods compute gradients of expected reward with respect to policy parameters and update parameters in the direction of improvement. Actor-critic methods combine policy learning (actor) with value function estimation (critic) to reduce variance and accelerate learning. The absence of explicit modeling requirements enables direct policy learning to scale to complex, high-dimensional relationship spaces that would be intractable for model-based approaches.

RAG integration 1908 implements retrieval augmented generation, enhancing neural network capabilities with external knowledge retrieval. For relationship-based training data, RAG integration 1908 enables the system to retrieve relevant historical relationship patterns, similar entity pair configurations, and domain-specific relationship knowledge to augment the neural network's learning process. The retrieval mechanism identifies training examples most relevant to the current learning context, enabling more efficient learning from limited experience and better generalization to novel relationship configurations.

Generative processing 1910 enables handling of novel scenarios through creative solution generation. When encountering relationship configurations not well-represented in training data, generative processing synthesizes appropriate responses by combining learned patterns in novel ways. Generative models 1910 including variational autoencoders and generative adversarial networks enable the system to generate plausible relationship trajectories, simulate potential outcomes of different actions, and explore the space of possible relationship evolutions. This capability is particularly valuable for handling edge cases and unusual relationship patterns that may not have sufficient representation in historical training data.

Model-free reinforcement learning 1902 is particularly effective when relationship patterns are complex, high-dimensional, or exhibit dynamics that are difficult to capture in explicit state models. Scenarios with continuous state spaces, subtle interaction effects, and evolving relationship dynamics benefit from the flexible function approximation capabilities of neural networks. The ability to learn directly from experience without requiring explicit model construction makes model-free delivery suitable for novel contexts where relationship patterns have not been previously characterized.

FIG. 20 is a flow diagram of an example method 2000 for adaptive switching between model-based and model free approached for training data delivery, according to an embodiment of the invention.

Method 2000 may be executed by processor 511 in coordination with training effectiveness evaluator 568 by executing instructions stored in memory 512. These instructions, stored in non-transitory computer-readable memory and executed by one or more processors, enable continuous performance monitoring and intelligent switching between model-based and model-free delivery approaches based on domain-specific threshold evaluation.

At step 2001, method 2000 begins with a current delivery approach active, either model-based delivery (step 1703 from FIG. 17) or model-free delivery (step 1704 from FIG. 17). The system continuously monitors the active delivery approach to evaluate training effectiveness and determine whether the current approach should continue or whether adaptive switching should occur.

At step 2002, training effectiveness evaluator 568 may receive performance effectiveness metrics from the AI systems receiving the training data by a current delivery approach. In an example, performance effectiveness metrics are received from AI systems every N training iteration (for example, every 1,000 iterations) or after processing a defined percentage of training data (for example, every 10% of training combinations). This type of monitoring enables detection of performance degradation before the entire training process completes, allowing timely intervention and approach adjustment.

In an embodiment, receiving AI systems process the training data through either model-based reinforcement learning with Markov Decision Processes or model-free reinforcement learning with neural networks (depending on the delivery mechanism selected by the communication management server 506), they generate performance effectiveness metrics including prediction accuracy 2004, learning convergence rate 2006, generalization capability 2008, and computation efficiency 2010. These performance effectiveness metrics are transmitted back to the communication management server through a feedback channel, enabling the adaptive switching mechanism

In an embodiment, prediction accuracy 2004 measures how correctly the system forecasts outcomes, quantifying the percentage of correct predictions on validation data held out from training. The metric is calculated by AI systems as:

$$PA = ( TP + TN ) / ( TP + TN + FP + FN ) \times 100 \%$$

where: PA=prediction accuracy percentage, TP=True positives (correctly predicted positive outcomes), TN=true negatives (correctly predicted negative outcomes), FP=false positives (incorrectly predicted positive outcomes), FN=false negatives (incorrectly predicted negative outcomes). For multi-class prediction scenarios, accuracy is calculated as the ratio of correct predictions to total predictions across all classes. The validation dataset comprises a held-out portion (typically 10-20%) of the training combination data that is not used during model training.

In an embodiment, learning convergence rate 2006 measures how quickly the system approaches optimal policies, quantified as the rate of improvement in objective function value over training iterations. The metric is calculated by AI systems based on the rate of improvement in the objective function over training iterations:

$$LCR = ( 1 - ( L\_current / L\_initial ) ) / ( N\_iterations / N\_expected ) \times 100 \%$$

where: LCR=Learning Convergence Rate percentage, L_current=Current loss/objective function value, L_initial=Initial loss/objective function value at training start, N iterations=Number of training iterations completed, N_expected=Expected iterations for convergence (domain-specific baseline)

A convergence rate of 100% indicates the system is converging at exactly the expected rate. Values above 100% indicate faster-than-expected convergence, while values below 100% indicate slower convergence. The metric is capped at 150% to prevent outlier effects from skewing evaluation.

In an embodiment, generalization capability 2008 is measured by AI systems to determine how well the system handles previously unseen scenarios, evaluated through performance on test data representing novel relationship configurations not present in training data. The metric compares performance on training data versus test data:

$$GC = ( 1 - \vert P\_train - P\_test \vert / P\_train ) \times P\_test \times 100 \%$$

where: GC=Generalization Capability percentage, P_train=Performance (accuracy) on training data, P_test=Performance (accuracy) on held-out test data

This formula penalizes both overfitting (P_train>>P_test) and underfitting (low P_test). The ideal generalization capability approaches 100% when training and test performance are both high and similar. The test dataset comprises relationship configurations not present in the training data, representing novel scenarios the system may encounter in production.

In an embodiment, computational efficiency 2010 may be computed by AI systems to measure resource utilization relative to training progress, quantified as the improvement in training objective per unit of computational resource (time, memory, or processing cycles) consumed.

The metric quantifies how effectively computational resources are converted into training improvement:

$$CE = ( Δ Performance / Δ Resources ) / ( ΔPerformance\_baseline / ΔResources\_baseline ) \times 100 \%$$

where: CE=Computational Efficiency percentage, APerformance=Improvement in prediction accuracy over measurement period, AResources=Computational resources consumed (CPU-hours+GPU-hours×GPU_weight), APerformance_baseline=Expected performance improvement for domain, AResources_baseline=Expected resource consumption for domain

Resource consumption is measured in normalized compute units combining CPU time, GPU time (weighted by GPU_weight, typically 4-8×CPU weight), and memory utilization. An efficiency of 100% indicates resource utilization matching baseline expectations, while higher values indicate more efficient resource usage.

At step 2012, training effectiveness evaluator 568 may identify the domain from the domain identifiers in the training combination data and load domain-specific primary metric thresholds. Different application domains designate different performance effectiveness metrics as primary based on the specific requirements and risk tolerances of each domain. For example, healthcare and financial domains, prediction accuracy 2004 and generalization capability 2008 are designated as primary metrics due to the high stakes of incorrect predictions in medical and financial contexts. In another example, entertainment and social media domains, computational efficiency 2010 and learning convergence rate 2006 are designated as primary metrics due to the emphasis on real-time response and rapid adaptation in user-facing applications.

In an exemplary embodiment, the following table shows the primary metrics and respective domain-specific thresholds ranges:

| Domain | Primary Metrics | Threshold Range |
|---|---|---|
| Healthcare | Prediction Accuracy, Generalization | 92%-95% |
| | Capability | |
| Financial | Prediction Accuracy, Generalization | 90%-92% |
| | Capability | |
| Entertainment | Computational Efficiency, Learning | 82%-85% |
| | Convergence Rate | |
| Social media | Computational Efficiency, Learning | 80%-82% |
| | Convergence Rate | |

In some cases, the domain-specific threshold may be a range as shown in the above example. In other cases, the domain-specific threshold may be specific number from the threshold range based on user configuration. Further, the threshold ranges may be configurable.

In an embodiment, domain-specific thresholds for primary metrics may be determined through multiple approaches including static configuration, dynamic learning, administrator configuration, or hybrid methods. The system supports flexible threshold determination to accommodate different deployment contexts and organizational requirements.

In case of static configuration, domain-specific thresholds may be pre-defined based on industry standards, regulatory requirements, and empirical best practices. The static thresholds are stored in a threshold configuration database and loaded at system initialization. Static configuration is appropriate for regulated industries where threshold values must remain consistent and auditable.

The static threshold values are determined through the following methodology:

$$T\_domain = T\_base + T\_risk \_adjustment + T\_regulatory \_adjustment$$

$$where :$$

$$T\_domain = final domain - specific threshold value , T\_base = base threshold value ( default 80 \% ) , T\_risk \_adjustment = risk - based adjustment factor ( 0 \% to 15 \% ) , and T\_regulatory \_adjustment = regulatory compliance adjustment ( 0 \% to 5 \% )$$

In case of dynamic configuration, the system may learn optimal threshold values from historical performance data. The dynamic learning approach analyzes past switching decisions and their outcomes to refine threshold values over time. Dynamic thresholds adapt to changing data characteristics and evolving performance patterns. The dynamic threshold adjustment is calculated as:

$$T\_dynamic ( t + 1 ) = T\_dynamic ( t ) + α \times ( P\_target - P\_actual )$$

$$Where$$

$$T\_dynamic ( t + 1 ) = Adjusted threshold for next period , T\_dynamic ( t ) = Current threshold value , α = Learning rate ( typically 0.01 to 0.1 ) , P\_target = Target performance level for the domain , P\_actual = Actual observed performance after switching / continuing$$

The dynamic learning process maintains a bounded threshold range to prevent extreme values. The threshold bounds are defined as T_min≤T_dynamic≤T_max, where T_min is typically 70% and T_max is typically 98%. If the calculated threshold falls outside these bounds, it is clamped to the nearest boundary value.

Further, the system may support administrator-configurable thresholds through adaptive parameter controller 560. Administrators may adjust threshold values through a configuration interface that accepts threshold specifications in the following format:

$$ThresholdConfig = \{ domain\_id , metric\_id , threshold\_value , effective\_date , expiry\_date \}$$

Administrator-configured thresholds override static defaults but are subject to validation constraints that ensure threshold values remain within acceptable ranges for the specified domain. The system logs all threshold configuration changes for audit purposes and supports threshold rollback to previous values if configured thresholds produce suboptimal results.

At step 2014, training effectiveness evaluator 568 compares each primary metric against its domain-specific threshold. This evaluation determines whether the primary performance requirements for the specific application domain are being met. The comparison is performed for each primary metric individually, and any primary metric falling below its threshold triggers the switching pathway.

At step 2014, when any of the primary metric falls below the domain-specific threshold, method 2000 proceeds to step 2016 to switch between model-free delivery and model-based delivery. At step 2016, the system executes adaptive switching with knowledge preservation. When switching from model-free to model-based delivery, the system extracts implicit state representations learned by the neural networks, analyzing weight patterns and activation functions to construct explicit state definitions and transition probability estimates for the MDP framework. When switching from model-based to model-free delivery, the system initializes neural network weights using the existing state model knowledge, encoding state-transition relationships and reward function parameters into initial network configurations that provide a warm start for gradient-based optimization. This bidirectional knowledge transfer ensures that switching approaches does not discard previously accumulated learning, enabling the system to continue training from an informed starting point rather than beginning from scratch.

At step 2014, when all the primary parameters are above the domain-specific threshold, method 2000 proceeds to step 2018 to evaluate secondary metrics. Secondary metrics are the performance effectiveness metrics not designated as primary metrics for the current domain. At step 2018, training effectiveness evaluator 568 may calculate a composite metric for the secondary parameters, which are the performance effectiveness parameters not designated as primary for the current domain. The composite metric is calculated as a weighted combination of the secondary metric values, with weights reflecting the relative importance of each secondary metric for overall training effectiveness.

The composite metric provides a unified score representing overall performance on non-critical dimensions and is calculated as a weighted average of secondary metric values:

$$CM = \sum ( w\_i \times M\_i ) / \sum w\_i$$

$$Where :$$

$$CM = Composite Metric value ( percentage ) , w\_i = Weight assigned to secondary metric I , M\_i = Value of secondary metric i ( percentage ) , \sum w\_i = Sum of all weights ( for normalization )$$

The weights for secondary metrics are assigned based on their relative importance for overall training effectiveness within each domain. In preferred embodiments, equal weights are assigned to secondary metrics:

$$w\_i = 1. for all secondary metrics ( equal weighting )$$

With equal weighting and two secondary metrics, the composite calculation simplifies to:

$$CM = ( M\_secondary 1 + M\_secondary 2 ) / 2$$

In an example, healthcare and financial domains where prediction accuracy and generalization capability are primary metrics, the secondary metrics are learning convergence rate and computational efficiency. For entertainment and social media domains where computational efficiency and learning convergence rate are primary metrics, the secondary metrics are prediction accuracy and generalization capability. The composite metric is calculated as a weighted combination of the secondary metric values, with weights reflecting the relative importance of each secondary metric for overall training effectiveness.

At step 2020, training effectiveness evaluator 568 compares the composite metric against a universal threshold. The universal threshold represents the minimum acceptable combined performance on secondary metrics regardless of domain. As used herein, “universal threshold” refers to a minimum acceptable value for the composite score of secondary metrics that applies uniformly across all application domains. The universal threshold represents the minimum acceptable combined performance on non-critical metrics regardless of domain, ensuring that overall training effectiveness is not compromised even when primary metrics are satisfactory. The universal threshold may be adjusted through adaptive parameter controller 560, with valid values ranging from 50% to 90%. In some embodiments, the universal threshold is set at 75%.

This second evaluation ensures that while primary parameters are meeting domain-specific requirements, the overall training effectiveness is not being compromised by poor performance on secondary metrics.

At step 2020, when the composite metric falls below the universal threshold method 2000 proceeds to step 2024 to optimize the current delivery approach.

In an embodiment, at step 2024, the system implements parameter tuning and configuration adjustments to improve secondary metric performance while maintaining the current delivery approach.

In an embodiment, the adaptive switching mechanism implements knowledge preservation to minimize training disruption and avoid redundant computation. When switching from model-free delivery to model-based delivery, the system extracts implicit state representations learned by neural networks to construct explicit state definitions and transition probability estimates for the MDP framework. When switching from model-based delivery to model-free delivery, the system initializes neural network weights using existing state model knowledge to provide a warm start for gradient-based optimization. This bidirectional knowledge transfer ensures that accumulated learning is preserved across delivery approach transitions.

Method 2000 provide substantial advantages over conventional training data delivery approaches by implementing adaptive selection between model-based and model-free reinforcement learning approaches based on state model availability. The system implements domain-specific primary metric designation that recognizes different performance requirements across application domains. The two-tier threshold evaluation distinguishes between fundamental approach failures requiring switching and secondary performance issues addressable through optimization. Further, the knowledge preservation mechanisms maintain accumulated learning during delivery approach transitions.

### Optimization Operations at Step 2024

The optimization operations may include specific parameter adjustments tailored to improve secondary metric performance. In an embodiment, f may be implemented by modifying the step size used in gradient-based optimization to accelerate convergence (increasing learning rate) or improve stability (decreasing learning rate). For model-free delivery, this adjusts neural network training. For model-based delivery, this adjusts policy iteration step sizes.

In an embodiment, batch size tuning may be performed by adjusting the number of training samples processed per update iteration. Larger batch sizes improve computational efficiency through parallelization while smaller batch sizes may improve generalization through increased stochasticity.

In an embodiment, exploration-exploitation rebalancing includes adjusting the trade-off between exploring new actions and exploiting known good actions. Reducing exploration when primary metrics are satisfactory but secondary convergence is slow.

In an embodiment, regularization adjustment may be performed by modifying regularization parameters (L1, L2, dropout) to improve generalization or reduce overfitting, applicable primarily to model-free delivery.

In an embodiment, resource allocation optimization may be performed by redistributing computational resources between different training operations to improve overall efficiency without changing the fundamental approach.

In an embodiment, early stopping adjustment may be performed by modifying patience parameters that control when training terminates due to diminishing returns, balancing training thoroughness against computational efficiency.

Following optimization at step 2024, method 2000 returns to step 2001 to continue monitoring with the optimized parameters. The system maintains the current delivery approach but with adjusted configurations intended to improve secondary metric performance while preserving the satisfactory primary

At step 2020, when the composite metric is above the universal threshold, method 2000 continues with the current delivery approach. The system maintains the active delivery methodology while continuing performance monitoring through the loop back to step 2002. This continuous monitoring ensures that any future performance degradation will be detected and addressed through either optimization or adaptive switching as appropriate.

### Knowledge Preservation During Adaptive Switching

When ASF 510 triggers adaptive switching at step 2016, the system preserves accumulated learning to minimize training disruption and avoid redundant computation. When switching from model-free to model-based delivery, the system extracts implicit state representations learned by the neural network, analyzing weight patterns and activation functions to construct explicit state definitions and transition probability estimates for the MDP framework. The neural network's learned feature representations are mapped to discrete states, and the network's predictions of state transitions are converted to explicit probability distributions. This extraction process typically completes within milliseconds, introducing minimal latency while capturing the essential learned structure.

Conversely, when switching from model-based to model-free delivery, the system initializes neural network weights using the existing state model knowledge, encoding state-transition relationships and reward function parameters into initial network configurations that provide a warm start for gradient-based optimization. The state definitions inform the network's input representation, the transition probabilities inform initial weight configurations in recurrent or attention layers, and the reward function parameters inform the network's value output initialization. This warm start significantly reduces the training iterations required to achieve optimal performance after switching, as the network begins from an informed configuration rather than random initialization.

The bidirectional knowledge transfer mechanism ensures that adaptive switching improves rather than disrupts training effectiveness. By preserving learned representations and leveraging prior knowledge to initialize new approaches, the system achieves the benefits of approach switching without sacrificing the training progress accumulated under the previous approach. This knowledge preservation capability distinguishes the adaptive switching mechanism from naive approach replacement, enabling continuous optimization across approach boundaries.

### Implementation Example 1 Primary Metric Failure Triggering Switch (Healthcare Domain)

A healthcare relationship training system operates with model-based delivery. At step 2002, training effectiveness evaluator 568 receives the following performance effectiveness metrics from AI systems:
Prediction accuracy (2004): 89%
Learning convergence Rate (2006): 85%
Generalization capability (2008): 91%
Computational efficiency (2010): 78%

At step 2012, the system identifies the healthcare domain and loads domain-specific thresholds. For healthcare, prediction accuracy and generalization capability are designated as primary metrics with thresholds of 92% each. At step 2014, the system compares primary metrics against the domain-specific thresholds. The prediction accuracy of 89% is blow the domain-specific threshold 92%. As the primary metric falls below the domain-specific threshold, method 2000 proceeds to step 2016 to switch from model-based delivery to model-free delivery with knowledge preservation. The neural network approach may provide better flexibility to achieve the required accuracy through deeper pattern recognition.

### Implementation Example 2-Secondary Metric Failure Triggering Optimization Financial Domain)

A financial services training system operates with model-free delivery. At step 2002, training effectiveness evaluator 568 receives the following performance effectiveness metrics from AI model:
Prediction accuracy (2004): 93%
Learning convergence rate (2006): 68%
Generalization capability (2008): 91%
Computational efficiency (2010): 65%

At step 2012, the system identifies the financial domain and loads domain-specific thresholds. For financial services, prediction accuracy and generalization capability are designated as primary metrics with thresholds of 90% each. At step 2014, the system compares primary metrics against thresholds. Prediction accuracy of 93% is greater than threshold of 90% and the generalization capability of 91% is greater than threshold of 90%. Since all primary metrics meet their thresholds, method 2000 proceeds to step 2018.

At step 2018, the system calculates the composite metric for secondary metrics (learning convergence rate and computational efficiency):

$$Composite metric = ( 0 \text{.5} \times 68 \% ) + ( 0.5 \times 65 \% ) = 66.5 \% .$$

At step 2020, the system compares the composite metric (66.5%) against the universal threshold (for example 75%). As the composite metric is below the universal threshold, method 2000 proceeds to step b to optimize the current model-free delivery approach. The system may adjust learning rate, batch size, and regularization parameters to improve convergence and efficiency while maintaining the neural network approach that is achieving satisfactory accuracy and generalization.

The skilled person will be aware of a range of possible modifications of the various embodiments described above. Accordingly, the present invention is defined by the claims and their equivalents.

What is claimed is:

1. A system for adaptive training data delivery optimization, the system comprising:
a communication management server comprising one or more processors, a memory, and a plurality of programming instructions stored in the memory, the plurality of programming instructions when executed by the one or more processors causes the one or more processors to:
receive entity interaction data from a plurality of entities;
generate N (N−1)/2 training data therefrom, wherein the generated training data comprises multi-dimensional relationship vectors, relationship labels, and domain identifiers;
determine whether defined state models with transition probabilities are available;
responsive to the availability of the defined state models with transition probabilities, utilize model-based delivery implementing model-based reinforcement learning to deliver training data to AI systems;
responsive to non-availability of the defined state models with transition probabilities, utilize model-free delivery implementing model-free reinforcement learning using neural networks to deliver training data to the AI systems;
receive, performance effectiveness metrics from the AI systems receiving the training data, wherein performance effective metrics comprise prediction accuracy, learning convergence rate, generalization capability, and computational efficiency;
identify a domain associated with the training data;
determine, for the domain, designated primary metrics among the performance effectiveness metrics;
for each primary metric, compare the primary metric against respective domain-specific threshold;
responsive to any of the primary metric being below respective domain-specific threshold, switch the delivery mechanism between the model-based delivery and the model-free delivery and vice versa, wherein an adaptive switching mechanism switches a current delivery mode between the model-free delivery and the model-based delivery and vice versa;
responsive to all of the primary parameters being above respective domain-specific thresholds, calculate a composite metric for secondary metrics, wherein the secondary metrics are the performance effectiveness metrics left after the primary parameters; and
responsive to the composite metric being below the universal threshold, optimize the current delivery approach.

2. The system of claim 1, wherein the domain-specific thresholds are user-configurable, and wherein the domain-specific thresholds may be a range or a specific number from the range.

3. The system of claim 1, wherein to switch the current delivery mode, the plurality of programming instructions, when executed by the one or more processors, causes the one or more processors to:
when switching from the model-free delivery to the model-based delivery, extract implicit state representations learned by neural networks to construct explicit state definitions and transition probability estimates.

4. The system of claim 1, wherein to switch the current delivery mode, the plurality of programming instructions, when executed by the one or more processors, causes the one or more processors to:
when switching from the model-based delivery to the model-free delivery, initialize neural network weights using existing state model knowledge to provide a warm start for gradient-based optimization.

5. The system of claim 1, wherein the plurality of programming instructions, when executed by the one or more processors, causes the one or more processors to:
responsive to the composite metric being above the universal threshold, continue the current delivery approach.

6. The system of claim 1, wherein the plurality of programming instructions, when executed by the one or more processors, causes the one or more processors to monitor the performance effectiveness metrics for predefined number of training iterations or after processing a defined percentage of training data.

7. The system of claim 1, wherein to optimize the current delivery approach, the plurality of programming instructions, when executed by the one or more processors, causes the one or more processors to:
adjust learning rate to accelerate or stabilize convergence;
perform batch size tuning to improve computational efficiency through parallelization;
perform exploration-exploitation rebalancing to improve convergence;
perform regularization adjustment to improve generalization; and
optimize resource allocation to improve efficiency.

8. The system of claim 1, wherein the multi-dimensional relationship vectors comprise temporal dimensions, behavioral dimensions, communication frequency dimensions, and channel preference dimensions.

9. A method for adaptive training data delivery optimization, the method comprising:
receiving, at a communication management server, entity interaction data from a plurality of entities;
generating N (N−1)/2 training data therefrom, wherein the generated training data comprises multi-dimensional relationship vectors, relationship labels, and domain identifiers;
determining whether defined state models with transition probabilities are available;
responsive to the availability of the defined state models with transition probabilities, utilizing model-based delivery implementing model-based reinforcement learning to deliver training data to AI systems;
responsive to non-availability of the defined state models with transition probabilities, utilizing model-free delivery implementing model-free reinforcement learning using neural networks to deliver training data to the AI systems;
receiving, the performance effectiveness metrics from the AI systems, wherein the performance effective metrics comprise prediction accuracy, learning convergence rate, generalization capability, and computational efficiency;
identifying a domain associated with the training data;
determining, for the domain, designated primary metrics among the performance effectiveness metrics;
for each primary parameter, compare the primary metric against respective domain-specific threshold;
responsive to any of the primary metric being below the respective domain-specific threshold, switching the delivery mechanism between the model-based delivery and the model-free delivery and vice versa, wherein an adaptive switching mechanism switches a current delivery mode between the model-free delivery and the model-based delivery and vice versa;
responsive to all of the primary parameters being above the respective domain-specific thresholds, calculating a composite metric for secondary metrics, wherein secondary metrics are the performance effectiveness metrics left after the primary parameters; and
responsive to the composite metric being below the universal threshold, optimizing the current delivery approach.

10. The method of claim 9, wherein the domain-specific thresholds are user-configurable, and wherein the domain-specific thresholds may be a range or a specific number from the range.

11. The method of claim 9, wherein the adaptive switching mechanism comprises the step of: when switching from the model-free delivery to model-based delivery, extracting implicit state representations learned by neural networks to construct explicit state definitions and transition probability estimates.

12. The method of claim 9, wherein the adaptive switching mechanism comprises the step of:
when switching from the model-based delivery to the model-free delivery, initializing neural network weights using existing state model knowledge to provide a warm start for gradient-based optimization.

13. The method of claim 9, the method further comprises the step of:
responsive to the composite metric being above the universal threshold, continuing the current delivery approach.

14. The method of claim 9, wherein the method comprises monitoring the performance effectiveness metrics for predefined number of training iteration or after processing a defined percentage of training data.

15. The method of claim 9, wherein optimizing the current delivery approach further comprises the steps of:
adjusting learning rate to accelerate or stabilize convergence;
performing batch size tuning to improve computational efficiency through parallelization;
performing exploration-exploitation rebalancing to improve convergence;
performing regularization adjustment to improve generalization; and
optimizing resource allocation to improve efficiency.

16. The method of claim 9, wherein the multi-dimensional relationship vector comprises temporal dimensions, behavioral dimensions, communication frequency dimensions, and channel preference dimensions.
